(19) United States
(12) Patent Application Publication
(10) Pub. No.: US 2011/0219607 A1
(43) Pub. Date: Sep. 15, 2011

(54) CATHODE ACTIVE MATERIALS AND METHOD OF MAKING THEREOF

(76) Inventors: Kirakodu S. Nanjundaswamy, Sharon, MA (US); Fan Zhang, Needham, MA (US); Jennifer A. Nelson, Waltham, MA (US); Paul A. Christian, Norton, MA (US)

(21) Appl. No.: 12/722,800

(22) Filed: Mar. 12, 2010

(51) Int. Cl. C01G 45/02; H01M 4/88; H01B 1/24; H01B 1/22; H01M 4/82

(52) U.S. Cl. 29/623.1; 423/605; 252/182.1; 252/506; 252/513; 252/512; 977/742

(57) ABSTRACT

A method of making a primary alkaline battery that includes a cathode including λ-MnO₂ as an active material, an anode including zinc or zinc alloy as an active material, a separator between the cathode and anode, and an alkaline electrolyte contacting the anode and cathode having improved discharge performance. Methods of making high-purity, essentially lithium-free λ-MnO₂ having high electrochemical activity from nominally stoichiometric lithium manganese oxide spinels are disclosed.

### TECHNICAL FIELD

The invention relates to cathode active materials and to methods of making cathode active materials.

### BACKGROUND

Batteries, such as alkaline batteries, are commonly used as electrical energy sources. Generally, a battery contains a negative electrode (anode) and a positive electrode (cathode). The negative electrode contains an electroactive material (such as zinc or zinc alloy particles) that can be oxidized; and the positive electrode contains an electroactive material (such as a manganese dioxide) that can be reduced. The active material of the negative electrode is capable of reducing the active material of the positive electrode. In order to prevent direct reaction of the active material of the negative electrode and the active material of the positive electrode, the electrodes are mechanically and electrically isolated from each other by an ion-permeable separator.

When a battery is used as an electrical energy source for a device, such as a cellular telephone, electrical contact is made to the electrodes, allowing electrons to flow through the device and permitting the oxidation and reduction reactions to occur at the respective electrodes to provide electrical power. An electrolyte solution in contact with both electrodes contains ions that diffuse through the separator between the electrodes to maintain electrical charge balance throughout the battery during discharge.

### SUMMARY

The invention relates to methods of making cathode active materials for alkaline batteries. The cathode active materials can include λ-MnO₂. The λ-MnO₂ can be synthesized via an improved method that includes treating a nominally stoichiometric lithium manganese oxide spinel with an aqueous acid solution, at temperatures below ambient room temperature, for example, between 0° C. and 10° C. In some embodiments, the low temperature acid extraction process can be repeated multiple times to remove essentially all the Li ions from the crystal lattice of the precursor spinel. For example, multiple treatments with an aqueous acid solution at low temperature can remove more than 90% (e.g., more than 94%, or more than 97%) of the Li ions originally present in the precursor spinel. For example, after the low temperature acid extraction process, the λ-MnO₂ can contain less than 0.3 wt % Li, less than 0.2 wt % Li, or less than 0.1 wt % Li.

In one aspect, the invention features a method of making λ-MnO₂, including (a) combining a lithium manganese oxide spinel having a formula of Li₁₊ₓMn₂₋ₓO₄, where −0.075≦x≦+0.075, and an aqueous acid solution at a temperature below 15° C. to form a slurry; (b) stirring the slurry at a temperature below 15° C. to remove 90% or more of the lithium from the lithium manganese oxide spinel to form λ-MnO₂; (c) separating the λ-MnO₂ from a supernatant liquid; (d) washing the separated λ-MnO₂ until the pH of the wash water is between 6 and 7; and (e) drying the λ-MnO₂.

In another aspect, the invention features a method of making a cathode, including (a) combining a lithium manganese oxide spinel and an aqueous acid solution at a temperature below 10° C. to form a slurry; (b) stirring the slurry at a temperature below 10° C. to delithiate the lithium manganese oxide spinel to form λ-MnO₂; (c) separating the λ-MnO₂ from a supernatant liquid; (d) washing the separated λ-MnO₂; (e) drying the λ-MnO₂; and (f) incorporating the λ-MnO₂ into a cathode.

In a further aspect, the invention includes a method of making a battery, including: (a) combining a lithium manganese oxide spinel and an aqueous acid solution at a temperature below 10° C. to form a slurry; (b) stirring the slurry at a temperature below 10° C. to delithiate the lithium manganese oxide spinel to form λ-MnO₂; (c) separating the λ-MnO₂ from a supernatant liquid; (d) washing the separated λ-MnO₂; (e) drying the λ-MnO₂; (f) incorporating the λ-MnO₂ into a cathode; and (g) incorporating the cathode into a battery.

Embodiments can include one or more of the following features.

The λ-MnO₂ can be synthesized from a nominally stoichiometric lithium manganese oxide spinel by removal of essentially all lithium ions (e.g., more than 90%, more than 94%, more than 97%) from the crystal lattice of the precursor spinel by a delithiation process that includes extraction with an aqueous acid solution at temperatures below ambient room temperature, for example, between 0° C. and 10° C. The precursor spinel (e.g., the nominally stoichiometric lithium manganese oxide spinel) can be prepared by heat treatment of a mixture of a chemically prepared manganese dioxide (i.e., a CMD) and a lithium-containing compound. The CMD can be prepared by chemical oxidation of Mn²⁺ ions in a solution of a soluble manganese-containing compound, for example, a manganese(II) salt (e.g., manganous sulfate, manganous nitrate, manganous acetate, manganous chloride, manganous hydroxide).

The lithium manganese oxide spinel can have a general formula of Li₁₊ₓMn₂₋ₓO₄, wherein −0.05≦x≦+0.05 (e.g., −0.02≦x≦+0.02, or 0.00≦x≦+0.02). The lithium manganese oxide spinel has a lithium to manganese atom ratio of from 0.45 to 0.56 (e.g., 0.46 to 0.54, or 0.485 to 0.515). The lithium manganese oxide spinel can be prepared from a chemically synthesized manganese oxide precursor. The chemically synthesized manganese oxide can include a CMD, a pCMD, an amorphous manganese oxide, and a poorly crystalline spinel-type manganese oxide (e.g., a spinel-type manganese oxide having broad spinel peaks in the X-ray diffraction pattern). The CMD can have a crystal structure including α-MnO₂, β-MnO₂, ramsdellite, γ-MnO₂, γ-MnO₂, or ε-MnO₂, or a mixture, composite or intergrowth thereof. The pCMD can have a crystal structure including α-MnO₂, β-MnO₂, ramsdellite, γ-MnO₂, or ε-MnO₂, or a mixture, composite or intergrowth thereof. The lithium manganese oxide spinel can have a refined cubic unit cell constant between 8.2350 Å and 8.2550 Å (e.g., between 8.2420 Å and 8.2520 Å).

The lithium manganese oxide spinel can have a B.E.T. specific surface area between 1 and 10 m²/g (e.g., between 1 and 5 The lithium manganese oxide spinel has an average (mean) particle size less than 15 μm (e.g., less than 5 μm). The lithium manganese oxide spinel can have an X-ray crystallite size determined by the Scherrer method of between about 60 nm and 100 nm.

The aqueous acid solution can include aqueous solutions of sulfuric acid, nitric acid, hydrochloric acid, perchloric acid, toluenesulfonic acid, and trifluoromethylsulfonic acid. The concentration of the aqueous acid solution can be between 0.1 and 12 M (e.g., between 1 and 10 M, between 4 and 8 M, or 6 M). The slurry temperature can be between 0° C. and 10° C. (e.g., between 0° C. and 5° C., or 2° C.).

Separating the λ-MnO₂ can include separating by decantation, suction filtration, pressure filtration, centrifugation or by spray drying. Washing the separated λ-MnO₂ can include washing with deionized water, distilled water, or an alkaline aqueous solution. Drying the λ-MnO₂ can include drying in air or in an inert atmosphere (e.g., nitrogen, argon) at a temperature above an ambient room temperature of 21° C. (e.g., less than 100° C., between 30° C. and 70° C., between 40° C. and 60° C.) and/or under a vacuum.

The formed λ-MnO₂ can have a refined cubic unit cell constant between 8.0200 Å and 8.0500 Å, or less than 8.0500 Å (e.g., less than 8.0400 Å). The formed λ-MnO₂ can a residual lithium content of between 0.1 wt % and 1.0 wt % (e.g., between 0.1 wt % and 0.5 wt %), or less than 1.0 wt % (e.g., less than 0.5 wt %, or less than 0.2 wt %). The formed λ-MnO₂ can have a B.E.T. specific surface area between 10 and 30 m²/g (e.g., between 15 and 25 m²/g), a cumulative desorption pore volume of between 0.060 and 0.110 cm³/g, and an X-ray crystallite size determined by the Scherrer method of greater than 50 nm (e.g., greater than 70 nm), or between 50 nm and 100 nm.

The method of making a cathode can include incorporating conductive additive particles and an optional binder into a cathode. The conductive additive can include conductive carbon, silver, nickel, and/or mixtures thereof. The conductive carbon can include graphite (e.g., non-expanded natural graphite, non-expanded synthetic graphite, and expanded graphite), carbon black, acetylene black, partially graphitized carbon black, carbon fibers, carbon nanofibers, vapor phase grown carbon fibers, graphene, carbon single wall nanotubes, and/or carbon multi-wall nanotubes. The non-expanded synthetic graphite can be an oxidation-resistant graphite. The method can further include milling (e.g., high-energy milling) a dry mixture of the λ-MnO₂ and the oxidation resistant graphite prior to incorporating the λ-MnO₂ into the cathode.

The method of making a battery can further include incorporating an anode, a separator and an electrolyte into the battery.

The anode can include zinc metal particles, zinc alloy particles, or a mixture thereof. The zinc particles can include zinc fines having a particle size small enough to pass through a 200 mesh size sieve, for example, zinc particles with an average (mean) particle size from about 1 to 75 μm or about 75

The battery can have gravimetric specific capacity of greater than 320 mAh/g (e.g., greater than 340 mAh/g, or greater than 370 mAh/g) of λ-MnO₂ when discharged at a nominal continuous discharge rate of 10 mA/g of λ-MnO₂. The battery can have a gravimetric specific capacity of greater than 270 mAh/g of λ-MnO₂ when discharged at a nominal continuous discharge rate of 100 mA/g of λ-MnO₂ to a cutoff voltage of 0.8 V.

Embodiments can include one or more of the following advantages.

In some embodiments, the synthesized λ-MnO₂ can contain a decreased amount of impurity phases compared to λ-MnO₂ prepared by prior art methods. By maintaining the temperature of a stirred mixture of a nominally stoichiometric lithium manganese oxide spinel and an aqueous acid solution below ambient room temperature during the acid extraction process, formation of undesirable manganese oxide side products can be minimized. It is believed that such side products can be generated by re-oxidation of dissolved Mn²⁺ ions by air and/or the λ-MnO₂ at temperatures greater than about 30° C. Side products can include Mn₂O₃, α-MnO₂, γ-MnO₂, β-MnO₂ or mixtures of thereof. Precipitation of solid side products onto the surface of the λ-MnO₂ particles can degrade performance of the λ-MnO₂ in electrochemical cells. For example, performing the acid extraction process at a relative low temperature of about 15° C., about 10° C., about 5° C. or about 2° C. can decrease the likelihood of formation of side products.

In other embodiments, alkaline cells with cathodes including λ-MnO₂ prepared by acid extraction of a nominally stoichiometric lithium manganese oxide spinel at a low temperature, for example, between 0° C. and 10° C., can provide a greater specific capacity and higher average discharge voltage than cells containing λ-MnO₂ prepared by acid extraction methods performed at higher temperatures, for example, at ambient room temperature (e.g., 21° C.) or above, for example, between about 50° C. and 90° C. In addition, alkaline cells with cathodes including λ-MnO₂ prepared by low temperature acid extraction of a nominally stoichiometric lithium manganese oxide spinel can have greater specific capacities and higher discharge voltages than cells containing a λ-MnO₂ prepared from a non-stoichiometric precursor spinel, for example, a spinel containing excess lithium. Further, alkaline cells with cathodes including λ-MnO₂ prepared by low temperature acid extraction of a nominally stoichiometric spinel synthesized from a CMD-type precursor can have greater specific capacities and higher discharge voltages than cells containing a λ-MnO₂ prepared from a spinel synthesized from an electrochemically oxidized manganese dioxide (i.e., an EMD) precursor.

In other embodiments, alkaline cells with cathodes including λ-MnO₂ prepared by acid extraction of a nominally stoichiometric lithium manganese oxide spinel at a low temperature, for example, between 0° C. and 10° C., can provide decreased hydrogen gassing at the zinc anode and improved capacity retention during storage compared to an alkaline cell not including the λ-MnO₂.

Other aspects, features, and advantages of the invention will be apparent from the drawing, description, and claims.

### DESCRIPTION OF DRAWINGS

FIG. 1 is a schematic side-sectional view of a battery;

FIG. 2a is a SEM micrograph at 10,000× magnification of a precursor γ-MnO₂ of an embodiment of a λ-MnO₂ cathode active material;

FIG. 2b is a SEM micrograph at 10,000× magnification of a precursor α-MnO₂ of an embodiment of a λ-MnO₂ cathode active material;

FIG. 2c is a SEM micrograph at 9,000× magnification of a precursor γ-MnO₂ of an embodiment of a λ-MnO₂ cathode active material;

FIG. 3 is a graph showing the X-ray powder diffraction patterns of the precursor γ-MnO₂ and α-MnO₂ compounds of FIGS. 2a, 2b, and 2c;

FIG. 4a is a SEM micrograph at 10,000× magnification of a precursor LiMn₂O₄ spinel of an embodiment of a λ-MnO₂ cathode active material;

FIG. 4b is a SEM micrograph at 10,000× magnification of an embodiment of a λ-MnO₂ cathode active material;

FIG. 5 is a graph showing discharge performance of embodiments of a battery with a cathode including a λ-MnO₂ or a commercial electrolytic manganese dioxide;

FIG. 6 is a graph showing discharge performance of embodiments of a battery with a cathode including a λ-MnO₂ or a commercial electrolytic manganese dioxide; and

FIG. 7 is a graph showing discharge performance of embodiments of a battery with a cathode including a λ-MnO₂ or a commercial electrolytic manganese dioxide.

### DETAILED DESCRIPTION

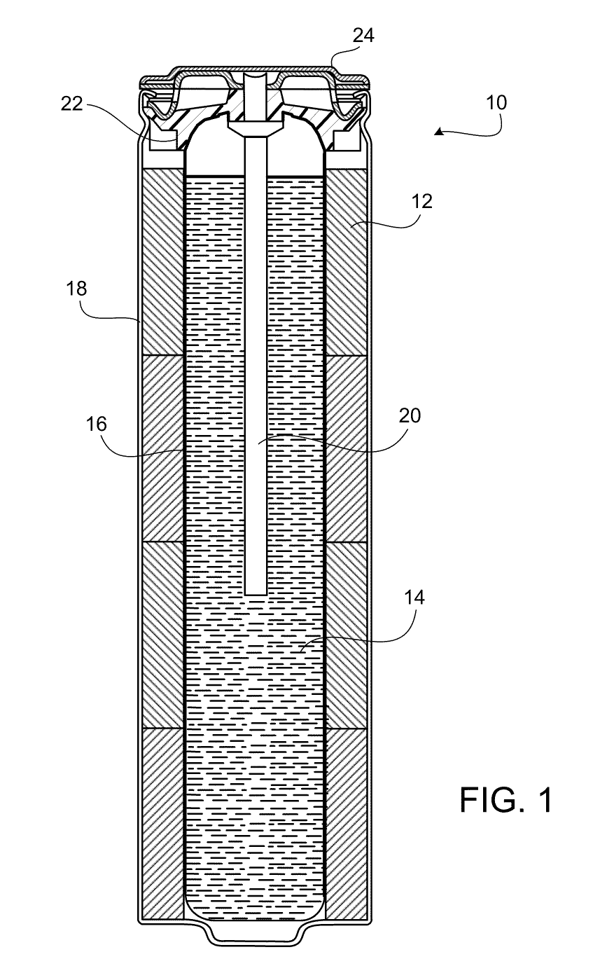

Referring to FIG. 1, a battery 10 includes a cylindrical housing 18, a cathode 12 in the housing, an anode 14 in the housing, and a separator 16 between the cathode and the anode. Battery 10 also includes a current collector 20, a seal 22, and a metal top cap 24, which serves as the negative terminal for the battery. Cathode 12 is in contact with housing 18, and the positive terminal of battery 10 is at the opposite end of battery 10 from the negative terminal. An electrolyte solution, e.g., an aqueous alkaline solution, is dispersed throughout battery 10.

Cathode 12 can include a cathode active material such as λ-MnO₂. As used herein, λ-MnO₂ is a crystalline manganese dioxide phase having a cubic spinel-related crystal structure and is described, for example, in U.S. Pat. No. 7,045,252. A suitable λ-MnO₂ can be synthesized by various methods including delithiation by extraction or washing with an aqueous acid solution of a nominally stoichiometric lithium manganese oxide spinel to remove essentially all the lithium ions from the spinel crystal lattice.

λ-MnO₂ can be synthesized by acid extraction of a lithium manganese oxide spinel (e.g., LiMn₂O₄) to remove the lithium ions. Previously, the acid extraction process was performed at between 10° C. and 90° C. (e.g., between 15° C. and 50° C.) for a duration of about 0.75 to about 24 hours as disclosed, for example, in U.S. Pat. Nos. 4,246,253; 4,312,930; 6,783,893; 6,932,846, by J. C. Hunter et al. (Journal of Solid State Chemistry, 1981, 39, 142-147; Proceedings of the Electrochemical Society, 1985, 85(4), 441-451). However, an improved low-temperature acid extraction process can be used to generate a high purity, single phase λ-MnO₂ from a nominally stoichiometric lithium manganese oxide of a spinel-type crystal structure (“spinel”). For example, maintaining a mixture of precursor spinel powder and aqueous acid solution at a temperature below ambient room temperature, for example at about 5° C., during the acid extraction process can minimize formation of undesirable manganese oxide reaction side products. In some embodiments, a λ-MnO₂ prepared by low temperature acid extraction can contain a decreased amount of impurity phases compared to λ-MnO₂ prepared using higher temperature extraction methods. Without wishing to be bound by theory, it is believed that reaction side products can be generated by re-oxidation of dissolved Mn²⁺ ions by air and can precipitate onto the surface of the λ-MnO₂ particles, thereby decreasing electrochemical activity. Further, it is believed that the soluble Mn²⁺ ions can be re-oxidized by Mn⁴⁺ ions on the surface of the λ-MnO₂ as described by D. Larcher et al. (Journal of the Electrochemical Society, 1998, 145(10), 3392-3400). Re-oxidation of dissolved Mn²⁺ ions can be rapid at slurry temperatures greater than about 50° C., for example, 95° C., and can result in the formation and precipitation of undesirable manganese oxides, such as Mn₂O₃, α-MnO₂ and γ-MnO₂, onto the surface of the λ-MnO₂ particles.

In general, in a low-temperature extraction process, solid lithium manganese oxide spinel powder is added to an aqueous acid solution that has been previously cooled to below 5° C., for example 2° C., with constant stirring to form a slurry. The temperature of the slurry can be maintained between −5° C. and 15° C. (e.g., preferably between 0° C. and 10° C.; more preferably between 0° C. and 5° C.) with constant stirring for about 4-12 hours. A solid product can be isolated from the liquid, washed with de-ionized water, and dried in air, to obtain λ-MnO₂. The aqueous acid solution can include, for example, aqueous solutions of sulfuric acid, nitric acid, hydrochloric acid, perchloric acid, toluenesulfonic acid, and/or trifluoromethylsulfonic acid. The concentration of the aqueous acid solution can range from 0.1 M to 10 M (e.g., from 1 M to 10 M, or from 4 M to 8 M). A preferred acid solution is 6 M sulfuric acid.

As used herein, the nominally stoichiometric lithium manganese oxide spinel can have a chemical composition corresponding to a general formula of Li₁₊ₓMn₂₋ₓO₄, where x ranges from −0.075 to +0.075, −0.05 to +0.05, and −0.02 to +0.02, for example, Li_{1.01}Mn_{1.99}O₄. In some embodiments, the nominally stoichiometric lithium manganese oxide spinel can be obtained from commercial sources. In other embodiments, a nominally stoichiometric lithium manganese oxide spinel can be chemically synthesized from suitable Li and Mn-containing precursors. For example, λ-MnO₂ can be synthesized from a nominally stoichiometric lithium manganese oxide spinel prepared from a small particle size, chemically-synthesized manganese dioxide (i.e., CMD) precursor. For example, the CMD can be a pCMD having a γ-MnO₂, ramsdellite or α-MnO₂-type crystal structure, prepared by the chemical oxidation of an aqueous solution of Mn²⁺ by a soluble peroxydisulfate salt (e.g., sodium peroxydisulfate, ammonium peroxydisulfate or potassium peroxydisulfate), as disclosed in U.S. Pat. No. 5,277,890. The pCMD can have a nanostructured particle morphology with a relatively high B.E.T. specific surface area typically ranging from about 10 to 60 m²/g. In some embodiments, λ-MnO₂ synthesized from a nominally stoichiometric lithium manganese oxide spinel prepared from pCMD can have up to 30% greater available specific energy density compared to a spinel prepared from a conventional commercial EMD, good high-rate discharge capability, and an average discharge voltage greater than about 1.2 V when included as an active material in the cathode of an alkaline primary battery.

Without wishing to be bound by theory, it is believed that acid extraction includes a step in which Mn³⁺ ions located on the surface of the spinel particles and in direct contact with the acid solution can disproportionate to form insoluble Mn⁴⁺ and soluble Mn²⁺ ions that dissolve in the acid solution along with the extracted Li ions according to Equation 1, as described, for example, by Q. Feng et al. (Langmuir, 1992, 8 1861-1867). Complete extraction of Li ions from the spinel can result in dissolution of about 25 mole % of the total Mn in the initial precursor spinel in the form of soluble Mn²⁺ ions. This corresponds to a total weight loss of about 28 wt % after acid extraction and includes weight loss attributable to the extracted Li ions as well as oxygen lost as water.

2LiMn³⁺Mn⁴⁺O₄+4H⁺→3λ-Mn⁴⁺O₂+Mn²⁺+2Li⁺+2H₂O (1)

Without wishing to be bound by theory, it is believed that in the case of a precursor spinel having an excess lithium stoichiometry, for example Li₁₊ₓMn₂₋ₓO₄, where +0.10≦x≦+0.33, the excess Li⁺ ions can be ion-exchanged by protons during the acid extraction process rather than oxidatively extracted from the lattice. However, in the case of a nominally stoichiometric spinel having a relatively slight excess of Li⁺ ions, for example Li₁₊ₓMn₂₋ₓO₄, where x<0.05, only a limited amount of ion-exchange of Li⁺ ions by protons can occur. Thus, the λ-MnO₂ formed by delithiation of such a nominally stoichiometric lithium manganese oxide spinel can be essentially “proton-free” as well as “lithium-free” and can function more effectively as a proton insertion cathode in an alkaline battery.

### Lithium Manganese Oxide Spinels

Lithium manganese oxide spinels (e.g., nominally stoichiometric lithium manganese oxides) can be obtained from various commercial sources. For example, precursor spinel powders can be obtained from Cams Corp. (Peru, Ill. USA), Konoshima Chemical Co. (Osaka, Japan) or Erachem-Comilog, Inc. (Baltimore, Md. USA) having an X-ray diffraction pattern, a refined cubic unit cell constant and a chemical composition consistent with that of stoichiometric lithium manganese oxide spinel. The refined cubic unit cell constant for lithium manganese oxide spinels having the general formula Li₁₊ₓMn₂₋ₓO₄ decreased linearly as the value of x increased from −0.15 to 0.25, as described, for example, in U.S. Pat. No. 5,425,932, and by Y. Gao and J. R. Dahn (Journal of the Electrochemical Society, 1996, 143(1), 100-114) for spinels with 0.00≦x≦0.14. As an example, a spinel powder can be obtained from Erachem-Comilog having a refined cubic unit cell constant of 8.2394 Å that corresponds to a slight lithium excess stoichiometry (e.g., x<0.02) as determined by elemental analysis. Similarly, a spinel powder can be obtained from Cams Corp. having a refined cubic unit cell constant of 8.2420 Å that corresponds to an even smaller lithium excess stoichiometry (e.g., x=0.01). Such a spinel can be prepared from an amorphous MnO₂ precursor (e.g., a CMD), for example, by the methods disclosed in U.S. Pat. Nos. 5,759,510 and 5,955,052. The refined cubic unit cell constant of a nominally stoichiometric lithium manganese oxide precursor spinel can range from 8.2350 Å to 8.2550 Å, from 8.2420 Å to 8.2520 Å. Desirably, the refined cubic unit cell constant of a nominally stoichiometric lithium manganese oxide precursor spinel is greater than 8.2350 Å, greater than 8.2400 Å, or greater than 8.2500 Å.

A commercial spinel powder can be obtained having a refined cubic unit cell constant that is consistent with values reported for spinels having larger lithium excess stoichiometries (e.g., Li₁₊ₓMn₂₋ₓO₄, where x≧0.1). For example, a commercial spinel powder can be obtained from Toda Kogyo Corp. (Yamaguchi, Japan), for example, HPM-6010, having a refined cubic unit cell constant of 8.1930 Å and the nominal chemical composition Li_{1.11}Mn_{1.89}O₄, with an excess lithium stoichiometry. Such a spinel can be prepared from a MnO₂ precursor (e.g., a CMD), for example, by the method disclosed in U.S. Pat. No. 6,428,766. Yet another commercial spinel powder having slight lithium excess stoichiometry having a refined cubic unit cell constant of 8.2310 Å and a nominal chemical composition of Li_{1.06}Mn_{1.94}O₄ can be obtained from Tronox Corp. (Oklahoma City, Okla.), for example, Grade 210.

In addition to commercial spinels, lithium manganese oxide spinels can be synthesized by any of a variety of well-known methods from various Li and Mn-containing precursors. For example, a lithium manganese oxide spinel can be prepared by the solid state reaction of an intimate mixture of a lithium compound and a manganese oxide in air at an elevated temperature (e.g., 700-800° C.) as described, for example, by M. M. Thackarey (Progress in Solid State Chemistry, 1997, 25, 1-75).

Spinels having relative small particle sizes and high specific surface areas can be prepared from corresponding small particle size, high specific surface area precursors synthesized, for example, by a sol-gel process. In a typical sol-gel process, a poly-functional carboxylic acid, for example, citric acid, tartaric acid, adipic acid or oxalic acid can be added to an aqueous solution containing Li⁺ ions and Mn²⁺ ions in the desired mole ratio of 1:2 to form a complex with the soluble metal ions, to ensure intimate mixing and compositional homogeneity on an atomic scale in the Li/Mn metal carboxylate solid that is formed when the water is removed. Following isolation, the solid metal carboxylate can be subjected to heat treatment to prepare a nominally stoichiometric spinel phase. Pyrolysis of the metal carboxylate at temperatures ≧250° C. in air rapidly evolves carbon dioxide that can generate high porosity in the formed spinel. In general, spinel powders prepared by a sol-gel process can have very high specific surface areas (e.g., >30 m²/g), small average particle sizes (e.g., <1 μm), and low bulk (<0.5 g/cm³) and tap (e.g., <1.0 g/cm³) densities. In some embodiments, a λ-MnO₂ prepared from such a precursor spinel powder also can have a corresponding high specific surface area, small average particle size, and low bulk and tap densities. In some embodiments, λ-MnO₂ powders with low tap densities (e.g., <0.5 g/cm³) can result in pressed cathode pellets having crush strength too low for cell assembly. In addition, electrochemical cells including cathode pellets fabricated from low density λ-MnO₂ powders can have undesirably low volumetric discharge capacities, compared to cells including cathode pellets fabricated from higher density λ-MnO₂ powders prepared from commercial spinels having higher bulk or tap densities.

A precursor for a lithium manganese oxide spinel also can be prepared from a small particle, crystalline, chemically-synthesized manganese (IV) oxide (i.e., a “CMD”) having a ramsdellite, γ-MnO₂ or α-MnO₂-type crystal structure. Such a CMD can be generated by chemical oxidation of an aqueous solution containing a soluble Mn²⁺ salt, for example, manganese sulfate or manganese nitrate with a strong oxidant, for example, a peroxydisulfate salt such as sodium peroxydisulfate (Na₂S₂O₈), potassium peroxydisulfate (K₂S₂O₈) or ammonium peroxydisulfate ((NH₄)₂S₂O₈) as in Equation 2 under controlled heating conditions. Other strong oxidants also can be used including, for example, sodium bromate (NaBrO₃), potassium bromate (NaBrO₃), potassium permanganate (KMnO₄), sodium permanganate (NaMnO₄), and lithium permanganate (LiMnO₄). Various methods for the preparation of small particles of various MnO₂ phases including α-MnO₂, β-MnO₂, ramsdellite, γ-MnO₂, and ε-MnO₂ by either chemical or electrochemical oxidation of Mn²⁺ salts under hydrothermal reaction conditions are described, for example, by L. I. Hill et al. (Electrochemical and Solid State Letters, 4(6) 2001, D1-3), X. Wang et al. (Journal of the American Chemical Society, 124(12), 2002, 2880-2881), H. Fang et al., (Journal of Power Sources, 2008, 184, 494-497), and L. Benhaddad et al. (Applied Materials and Interfaces, 2009, 1(2), 424-432).

Mn²⁺SO₄+M₂S₂O₈+2H₂O→Mn⁴⁺O₂+M₂SO₄+2H₂SO₄ (2)
where M=Na, K, NH₄

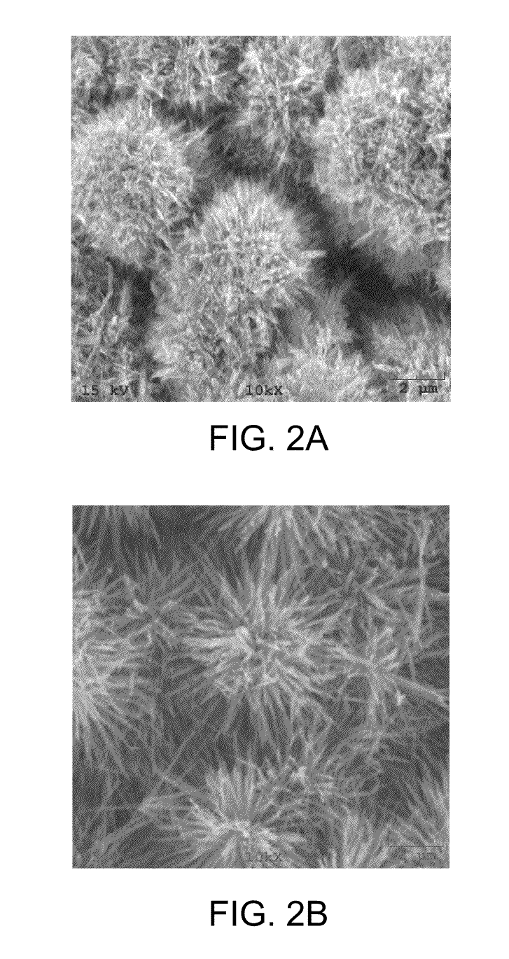

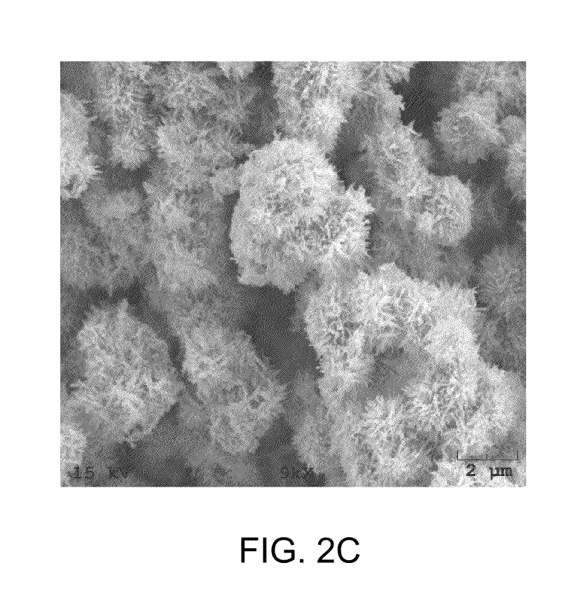

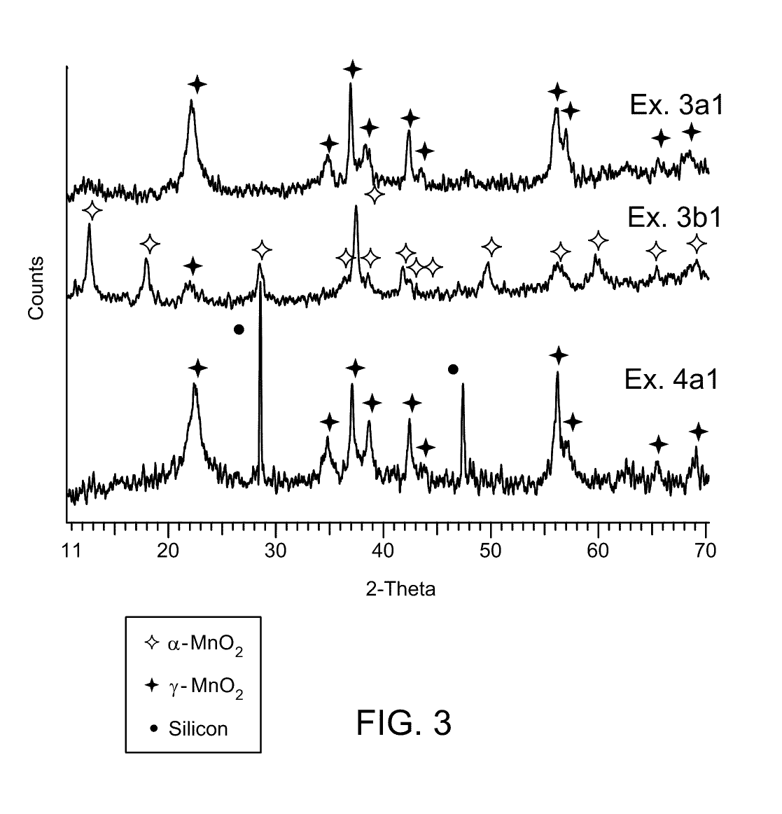

In some embodiments, a small particle, crystalline MnO₂ phase generally known as “p-CMD” having a ramsdellite, γ-MnO₂ or α-MnO₂-type crystal structure and a characteristic filamentary or sea urchin-like nanostructure shown, for example, in the SEM images of FIGS. 2a, 2b, and 2c, can be used advantageously as a precursor for the preparation of lithium manganese oxide spinel. Synthesis of such a p-CMD is disclosed for example, in U.S. Pat. No. 5,277,890 and also described by E. Wang et al. (Progress in Batteries and Battery Materials, 1998, 17, 222-231) and H. Abbas et al. (Journal of Power Sources, 1996, 58 15-21). For example, an equimolar amount of solid Na₂S₂O₈ powder can be added to a stirred 0.4 M MnSO₄ aqueous solution at 20° C. to form a solution that can be heated from 20° C. to 50° C. during a 2 hour period (i.e., a heating rate of 15° C./hr) and held at 50° C. for 18 hours with continuous stirring. The solution can then be heated from 50° C. to 65° C. during an 8 hour period (i.e., a heating rate of about 2° C./hr) and held at 65° C. for about 18 hours with continuous stirring. Next, the solution can be heated from 65° C. to 80° C. during an 8 hour period (i.e., a heating rate of about 2° C./hr) and then cooled from 80° C. to 20° C. in about 1 hour with continuous stirring to generate a solid product. The solid product can be isolated from the supernatant liquid, for example, by decantation, suction filtration, pressure filtration or centrifugation, washed with aliquots of distilled or de-ionized water until the washings have a neutral pH value (i.e., between about 6 and 7), and then dried in air for about 24 hours at 100° C. A pCMD having a predominantly ramsdellite or γ-MnO₂-type crystal structure can be identified by its characteristic X-ray powder diffraction pattern shown, for example, in FIG. 3.

In some embodiments, solid ammonium peroxydisulfate or an aqueous solution of (NH₄)₂S₂O₈ can be substituted for Na₂S₂O₈ or K₂S₂O₈ as the oxidizing agent. Depending on reaction temperature and time, the resulting small particle, crystalline pCMD formed by oxidation with (NH₄)₂S₂O₈ can have an α-MnO₂, γ-MnO₂ or ε-MnO₂-type crystal structure. For example, a pCMD having a predominantly α-MnO₂-type crystal structure can have a comparable specific surface area, but lower tap density than a pCMD having a γ-MnO₂-type crystal structure prepared using Na₂S₂O₈ as the oxidizing agent. The tap density of a pCMD prepared by oxidation with Na₂S₂O₈ can range from about 1.7 to 2.1 g/cm³ compared with about 0.8 to 1.6 g/cm³ for that of a pCMD prepared by oxidation with (NH₄)₂S₂O₈, depending on the reaction conditions. The specific surface areas of both pCMDs typically can range from about 20 to 50 m²/g. In other embodiments, solid potassium peroxydisulfate (K₂S₂O₈) or an aqueous solution of K₂S₂O₈ can be used as the oxidizing agent to prepare a pCMD having a α-MnO₂-type crystal structure.

In some embodiments, instead of using a solid oxidizing agent or an aqueous solution of a soluble oxidizing agent, such as a peroxydisulfate salt, a permanganate salt or a hypochlorite salt, a CMD having properties similar to pCMD can be prepared by passing ozone gas through a rapidly stirred aqueous solution containing 1 M Mn²⁺ and 1-2 M H₂SO₄ heated at 80° C. as described in Equation 3. The use of ozone gas to oxidize an aqueous Mn²⁺ solution is described, for example, by T. Nishimura et al. (Shigen-to-Sozai (Journal of the Mining & Materials Processing Institute of Japan), 1991, 107(11), 805-810), N. Kijima et al. (Journal of Solid State Chemistry, 159, 2001, 94-102), and J. Dai et al. (Proceedings of the 40^{th} Power Sources Conference, 2002, 283-286). The average particle size, specific surface area, and microstructure of the CMD generated by oxidation with ozone gas can depend on reaction temperature and acid concentration. For example, the CMD formed from a solution containing 1-2 M H₂SO₄ heated at <80° C. can be predominantly γ-MnO₂, whereas that formed from a solution containing 5 M H₂SO₄ heated at >80° C. can be α-MnO₂. Alternatively, a CMD formed by ozone oxidation of an aqueous 1 M Mn²⁺ solution containing about 2 M H₂SO₄ heated at >100° C. can have predominantly a ramsdellite (R—MnO₂) structure.

Mn²⁺SO₄+2O₃+3H₂O→3R—Mn⁴⁺O₂+3H₂SO₄+3/2O₂ (3)

A nominally stoichiometric lithium manganese oxide spinel can be synthesized by reacting hydrothermally-generated small particles of α-MnO₂, γ-MnO₂, R—MnO₂ or pCMD prepared by any of the methods described or cited above with a stoichiometric amount of a lithium salt. The lithium salt can include, for example, lithium hydroxide, lithium oxide, lithium carbonate, lithium acetate, lithium chloride, and/or lithium nitrate. In some embodiments, the reaction temperature can be 300° C. or more (e.g., 400° C. or more, 500° C. or more, 600° C. or more, or 700° C. or more) and/or 800° C. or less (700° C. or less, 600° C. or less, 500° C. or less, or 400° C. or less). In some embodiments, the duration of the reaction can be one hour or more (e.g., two hours or more, six hours or more, or twelve hours or more) and/or 24 hours or less (e.g., 12 hours or less, six hours or less, two hours or less).

For example, a γ-MnO₂ can be intimately mixed with a lithium salt such as lithium hydroxide, lithium oxide or lithium nitrate in a mole ratio of Mn:Li of 2:1 and heated at 300° C. to 450° C. in air for at least 1 hour, for at least 0.5 hour to form a stoichiometric lithium manganese oxide spinel, as described, for example, in U.S. Pat. No. 4,959,282. As another example, γ-MnO₂ can be treated in an aqueous solution of a soluble lithium compound, for example, 3 M LiOH at a temperature of from about 50° C. to 90° C. for a period of 2 to 3 hours with continuous aeration to form a lithiated manganese oxide that can be converted to a spinel by heat treatment at between 500° C. and 800° C. for 3 to 4 hours in air, as described, for example, in U.S. Pat. No. 6,334,993. In some embodiments, a stoichiometric lithium manganese oxide spinel can be prepared by hydrothermally treating an aerated slurry of γ-MnO₂ in distilled water with a 3M LiOH aqueous solution in a sealed autoclave at 120° C. to 180° C. under autogenous pressure for about 2 hours followed by heat treatment of the solid lithiated product at 500° C. to 800° C., as disclosed, for example, in U.S. Pat. No. 6,334,993.

In some embodiments, hydrothermally-prepared CMD having a ramsdellite or γ-MnO₂-type structure or pCMD having a α-MnO₂, γ-MnO₂ or ε-MnO₂-type structure can be reacted with lithium hydroxide in a Mn:Li mole ratio of 2:1 by means of a eutectic salt melt containing NaCl and KCl in a mole ratio of 1:1, with a ratio of the total weight of NaCl and KCl to CMD or pCMD of about 2:1, at between 750° C. and 800° C. for about 12 hours in air, to form a stoichiometric lithium manganese oxide spinel. The salt melt can be allowed to cool and solidify and the solid extracted with deionized water to dissolve the salts, and dried. The dried solid can be heated in air at between 700° C. and 800° C. for 8-12 hours to complete crystallization of the spinel phase as well as increase the size of the spinel crystallites.

In another embodiment, a small particle size CMD having a layered δ-MnO₂ or birnessite-type structure containing K⁺ ions (e.g., δ-KₓMnO₂) can be prepared by thermal decomposition of solid potassium permanganate in air at 600° C. according to a method described by S. Komaba et al. (Electrochimica Acta, 2000, 46, 31-35). The CMD powder can be treated with an aqueous solution of 5 M LiOH at between 75° C. and 85° C. to promote ion-exchange of K⁺ ions by Li ions and also to insert additional Li⁺ ions between the layers in the δ-MnO₂ structure by the method of Y. Lu et al. (Electrochimica Acta, 2004, 49, 2361-2367). The lithiated 6-MnO₂ can be heated in air at between 750° C. and 800° C. for 5 hours to convert the layered lithiated birnessite to a spinel phase.

### Synthesis of λ-MnO₂

As discussed herein above, a precursor lithium manganese oxide spinel for the synthesis of λ-MnO₂ can have a nominally stoichiometric composition, for example, corresponding to a general formula of Li₁₊ₓMn₂₋ₓO₄, wherein x ranges from −0.075 to +0.075 (from −0.05 to +0.05, or from −0.02 to +0.02), such as Li_{1.01}Mn_{1.99}O₄. Further, the lithium manganese oxide spinel can have a corresponding lithium to manganese atom ratio of from 0.45 to 0.56 (from 0.46 to 0.54, or from 0.485 to 0.515).

In some embodiments, it is believed that a larger fraction of the lithium ions can be extracted from a nominally stoichiometric spinel by the reaction of Equation 1 than from a spinel having an excess of lithium ions (e.g., a spinel having a general formula Li₁₊ₓMn₂₋ₓO₄, wherein 0.05≦x≦0.33, such as Li_{1.33}Mn_{1.67}O₄). In the case of a spinel having excess Li⁺ ions, the Li⁺ ions can occupy both the 16d octahedral sites and 8a tetrahedral sites in the cubic close packed oxygen lattice (i.e., Fd3m space group) as described by R. J. Gummow et al. (Solid State Ionics, 1994, 69, 59-67). In the case of a nominally stoichiometric spinel, the Li⁺ ions were found to occupy only the 8a tetrahedral sites by neutron powder diffraction, for example, as reported by C. Fong et al. (Zeitschrift fur Kristallographie, 1994, 209, 941-945). For each excess Li⁺ion occupying a 16d Mn⁴⁺ (i.e., vacancy) site, three Mn³⁺ ions must be oxidized to Mn⁴⁺ ions and/or some oxygen lost from the lattice to maintain overall electroneutrality of the spinel lattice. Extraction of Li⁺ ions from a spinel via the reaction of Equation 1 requires that one Mn³⁺ ion disproportionate to 0.5 Mn²⁺ and 0.5 Mn⁴⁺ for each Li⁺ ion removed. This also results in dissolution of 0.5 Mn²⁺ per Mn³⁺ ion. In the case of a nominally stoichiometric spinel, a majority of the Li⁺ ions can be removed from the spinel lattice to form a delithiated product having the nominal chemical formula λ-Li_{y}MnO₂, where 0<y≦0.2 as discussed by W. I. F. David et al. (Journal of Solid State Chemistry, 1987, 67(2), 316-323). Further, the residual Li⁺ ions were found to be located randomly on only the tetrahedral 8a lattice sites by neutron powder diffraction by W. I. F. David et al. (Journal of Solid State Chemistry, 1987, 67(2), 316-323) and C. Fong et al. (Zeitschrift fur Kristallographie, 1994, 209, 941-5).

In the case of a spinel having an excess lithium stoichiometry (i.e., 0.05≦x≦0.33), the total amount of lithium extracted by the reaction of Equation 1 can be decreased by an amount corresponding to three times the amount of the lithium excess as discussed by Q. Feng et al. (Langmuir, 1992, 8 1861-1867). The remaining Li⁺ ions can be removed via ion-exchange by protons (H⁺). In contrast to the extraction of Li⁺ ions by the oxidative delithiation reaction of Equation 1 in which the 8a lattice sites formerly occupied by Li⁺ ions are essentially vacant after repeated lithium extraction treatments, removal of Li⁺ ions by ion-exchange can result in occupation of the 8a sites by protons. For example, in the case of a lithium excess spinel having the nominal composition Li_{1.33}Mn_{1.67}O₄, where x=0.33, wherein all of the Mn is tetravalent (i.e., Mn⁴⁺), the Mn³⁺ disproportionation reaction of Equation 1 cannot take place. Instead, lithium removal can take place only by the proton-exchange reaction of Equation 4 accompanied by proton insertion. In the case of spinels having compositions with intermediate levels of excess lithium, for example, wherein 0.1<x<0.33, delithiation can take place simultaneously by the reactions of both Equation 1 and Equation 4. According to a model proposed by Q. Feng et al. (Langmuir, 1992, 8 1861-1867) for acid extraction of Li⁺ from spinel, the extent of proton insertion can depend on the relative proportion of Mn⁴⁺ vacancies in the 16d sites as well as the total amount of Mn³⁺ present in the lattice. Further, it is believed that delithiation can be partial or incomplete depending on the fraction of Li⁺ ions occupying 16d octahedral sites, since Li⁺ ions occupying octahedral sites are not ion-exchanged by protons as readily as Li⁺ ions in the 8a tetrahedral sites. It is also believed that the presence of unextracted (i.e., residual) Li⁺ ions as well as exchanged protons can result in lower specific capacity for alkaline cells with cathodes including ion-exchanged spinels because of poor diffusion kinetics due to repulsive electrostatic interactions between the protons inserted during discharge and the protons and residual Li⁺ ions present in the lattice.

3Li_{1.33}Mn_{1.67}O₄+4H⁺→3H_{1.33}Mn_{1.67}O₄+4Li⁺ (4)

In some embodiments, λ-MnO₂ having improved purity can be synthesized via an improved low-temperature acid extraction method. For example, an aqueous acid solution (e.g., 6 M H₂SO₄) can be cooled with stirring to between 0° C. and 5° C. A solid, finely-divided spinel powder is added to the cooled 6 M H₂SO₄ solution with constant stirring to form a slurry. The temperature is maintained between 0° C. and 5° C. and the slurry stirred for 2 to 12 hours under ambient atmosphere or an inert atmosphere (e.g., nitrogen, argon) to form an essentially delithiated λ-MnO₂ product. Stirring is stopped, the solids allowed to settle, and the solid product separated from the supernatant liquid, for example, by decantation, suction or pressure filtration or by centrifugation. The isolated solid product is next washed with multiple aliquots of distilled or de-ionized water until the aqueous washings have a nominally neutral pH value (i.e., between about 6-7), and the solid product dried in air for 4 to 24 hours at a temperature above ambient (e.g., 21° C.), for example <100° C. (e.g., between 30° C. and 70° C., or between 40° C. and 60° C.).

In some embodiments, the aqueous acid solution can include an aqueous solution of sulfuric acid, nitric acid, hydrochloric acid, perchloric acid, oleum (i.e., fuming sulfuric acid), toluenesulfonic acid, and/or trifluoromethylsulfonic acid. The acid solution can have a concentration of 0.1 M or more (e.g., 1 M or more, 2 M or more, 4 M or more, 6 M or more, 8 M or more, or 10 M or more) and/or 12 M or less (e.g., 10 M or less, 8 M or less, 6 M or less, or 4 M or less, or 2 M or less). For example, the acid solution can have a concentration of between 0.1 M and 10 M (e.g., between 1 M and 6 M, or between 2 M and 6 M). The acid solution can be a sulfuric acid solution having a concentration of 6 M. In some embodiments, when sulfuric acid is used in an acid treatment, the sulfuric acid can be recycled and reused in a manufacturing process, thereby providing a more environmentally friendly process.

The lithium manganese oxide spinel can be stirred with an aqueous acid solution at a temperature below ambient room temperature (e.g., below about 21° C.). In some embodiments, the acid extraction temperature is 15° C. or less (e.g., 10° C. or less, 5° C. or less, or 3° C. or less, or 2° C. or less) and/or 0° C. or more (e.g., 2° C. or more, 3° C. or more, or 5° C. or more). For example, the acid extraction temperature can be between 0° C. and 5° C. (e.g., between 0° C. and 10° C., between 0° C. and 15° C., between 0° C. and 2° C., or between 5° C. and 10° C.). In some embodiments, the temperature can be about 2° C. It is believed that acid extraction of a spinel at a low temperature below ambient room temperature can minimize formation of undesirable reaction side products (e.g., Mn₂O₃, γ-MnO₂ or pyrolusite ((3-MnO₂)) generated by re-oxidation of dissolved Mn²⁺ ions that can precipitate onto the surface of the formed λ-MnO₂ particles and degrade electrochemical discharge performance of alkaline cells with cathodes including the λ-MnO₂.

The lithium manganese oxide spinel can be stirred with an aqueous sulfuric acid solution for a duration of time of one hour or more (e.g., 2 hours or more, 4 hours or more, 8 hours or more, 12 hours or more, 18 hours or more, or 20 hours or more) and/or 24 hours or less (e.g., 20 hours or less, 18 hours or less, 12 hours or less, 8 hours or less, 4 hours or less, or 2 hours or less). In some embodiments, stirring with aqueous acid solution (e.g., sulfuric acid) can last from one to 24 hours (e.g., one to 12 hours, one to 6 hours, one to three hours, or 6 to 12 hours). The duration of acid extraction can depend on the concentration of the acid solution. For example, when a more concentrated acid solution is used, the duration of acid exposure can be relatively short. Conversely, when a less concentrated acid solution is used, the duration of acid exposure can be relatively long. The total amount of lithium manganese oxide spinel relative to the total amount of acid solution also can affect the duration of acid extraction, for example, a relatively small amount of lithium manganese oxide spinel can be extracted with a fixed volume of acid solution for a shorter duration than a relatively large amount of lithium manganese oxide spinel.

After acid extraction with an aqueous acid solution, the formed solid λ-MnO₂ can be isolated (e.g., by filtration, by sedimentation and decantation) and then washed repeatedly with portions of water (e.g., de-ionized water, distilled water) until the washings have a final pH of 4 or more (e.g., 5 or more, 6 or more, or 7 or more) and/or 8 or less (e.g., 7 or less, 6 or less, 5 or less, or 4 or less). In some embodiments, the solid λ-MnO₂ can be washed with an aqueous solution of an alkaline base, for example, NaOH, KOH, NH₄OH. The base solution can have a concentration of about 0.1 M or more (e.g., 0.2 M or more, 0.5 M or more, 0.7 M or more, or 1 M or more) and/or 2 M or less (e.g., 1 M or less, 0.7 M or less, 0.5 M or less, or 0.2 M or less). The pH of the alkaline base washings can be 8 or more (e.g., 9 or more, 10 or more, or 11 or more) and/or 12 or less (e.g., 11 or less, 10 or less, 9 or less, or 8 or less). After washing with water and/or base solution, the solid λ-MnO₂ is dried. For example, the λ-MnO₂ can be dried at a temperature of less than 100° C., for example, between 30° C. and 70° C. (e.g., between 40° C. and 60° C., or at about 50° C., at about 60° C., at about 70° C., at about 80° C., or at about 90° C.) in air or in an inert atmosphere (e.g., nitrogen, argon). The dried λ-MnO₂ can have a final water-content of between 1 wt % and 5 wt %. In some embodiments, the λ-MnO₂ can be dried under vacuum, with or without heating.

In some embodiments, the entire acid extraction process including the steps of washing and drying can be repeated multiple times, for example, two times or more or three times or more. The λ-MnO₂ powder resulting from repeated acid extraction can contain substantially less residual lithium (e.g., <0.4 wt %, <0.3 wt %, <0.2 wt %) than λ-MnO₂ prepared by a single acid extraction (e.g., >0.4 wt %, >0.5 wt %, >1 wt %) as well as have a greater specific surface area and larger average pore diameter.

In some embodiments, after acid extraction, the washed and dried λ-MnO₂ product powder can exhibit a total weight loss of about 28 wt % relative to the initial dry weight of lithium manganese oxide spinel powder. Since the total theoretical lithium content of the stoichiometric lithium manganese oxide spinel is about 3.84 wt %, without wishing to be bound by theory, it is believed that the observed weight loss of a nominally stoichiometric spinel after delithiation can be attributed predominantly to dissolution of the Mn²⁺ ions consistent with the reaction of Equation 1.

Values for the refined cubic unit cell constant, a₀ of nominally Li-free λ-MnO₂ typically can range between about 8.022 and 8.064 Å as reported, for example, by J. Read et al. (Electrochemical and Solid State Letters, 2001, 4(1), A162-165), T. Ohzuku et al. (Journal of the Electrochemical Society, 1990, 137, 769-775), and C. Fong and B. J. Kennedy (Zeitschrift fur Kristallographie, 1994, 209, 941-5). As observed for lithium manganese oxide spinels, the refined cubic unit cell constant of the spinel lattice of λ-MnO₂ can be correlated with the amount of residual lithium present in the lattice after acid extraction such that the smaller the aₒ value, the less lithium is present as observed, for example by A. Mosbah et al. (Materials Research Bulletin, 1983, 18, 1375-1381) and W. I. F. David et al. (Journal of Solid State Chemistry, 1987, 67(2), 316-323).

### Characterization

X-ray powder diffraction patterns for the precursor spinels and the corresponding λ-MnO₂ products can be measured with an X-ray diffractometer (e.g., Bruker D-8 Advance X-ray diffractometer, Rigaku Miniflex diffractometer) using Cu K_{α} or Cr K_{α} radiation using standard methods described, for example, by B. D. Cullity and S. R. Stock (Elements of X-ray Diffraction, 3^{rd} ed., New York: Prentice Hall, 2001). In some embodiments, the X-ray powder diffraction patterns of λ-MnO₂ powders prepared by the improved low-temperature acid extraction method are consistent with the standard powder diffraction pattern for λ-MnO₂ (i.e., Powder Diffraction File No. 44-0992, International Centre for Diffraction Data). The X-ray crystallite size of a spinel and the corresponding λ-MnO₂ also can be evaluated by analysis of peak broadening in a diffraction pattern containing an internal Si standard using the single-peak Scherrer method or the Warren-Averbach method as discussed in detail, for example, by H. P. Klug and L. E. Alexander (X-ray Diffraction Procedures for Polycrystalline and Amorphous Materials, New York: Wiley, 1974, 618-694).

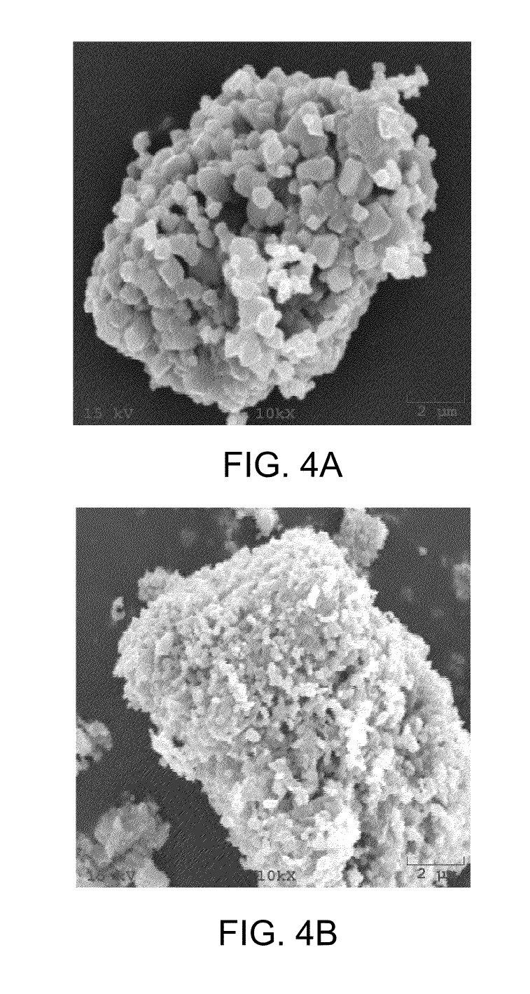

The specific surface areas of lithium manganese oxide spinel and λ-MnO₂ powders can be determined by the multipoint B.E.T. N₂ adsorption isotherm method described, for example, by P. W. Atkins (Physical Chemistry, 5^{th} edn., New York: W. H. Freeman & Co., 1994, pp. 990-992) and S. Lowell et al. (Characterization of Porous Solids and Powders: Powder Surface Area and Porosity, Dordrecht, The Netherlands: Springer, 2006, pp. 58-80). Typically, the specific surface area of a λ-MnO₂ can be substantially larger than the specific surface area of the corresponding spinel precursor. An apparent increase in specific surface area also can be observed by electron microscopy (e.g., SEM micrographs at 10,000× magnification). For example, an apparent increase in surface roughness and porosity of the surface of λ-MnO₂ particles (e.g., in FIG. 4b) imaged in SEM micrographs at 10,000× magnification compared to the corresponding precursor spinel particles (e.g., in FIG. 4a) can indicate an increase in specific surface area. The specific surface area of a λ-MnO₂ can be 200% or more, 300% or more, 400% or more, 500% or more, 600% or more, 700% or more, and/or 800% or less of the specific surface area of the corresponding precursor lithium manganese oxide spinel. In some embodiments, the specific surface area of a spinel powder is 1 m²/g or more and/or 10 m²/g or less. In some embodiments, the specific surface area of a λ-MnO₂ is 5 m²/g or more and/or 35 m²/g or less. For comparison, the specific surface area of a typical commercial EMD (γ-MnO₂) is about 48 m²/g.

Porosimetric measurements can be conducted on precursor lithium manganese oxide spinel powders and the corresponding λ-MnO₂ powders to determine cumulative pore volumes, average pore sizes (i.e., diameters), and pore size distributions. Pore size and pore size distributions were calculated by applying various models and computational methods (e.g., BJH, DH, DR, HK, SF) for analysis of the data from measurement of nitrogen adsorption and/or desorption isotherms as discussed by S. Lowell et al. (Characterization of Porous Solids and Powders: Powder Surface Area and Porosity, Dordrecht, The Netherlands: Springer, 2006, pp. 101-156). For example, the cumulative desorption pore volume calculated by the DH method for a λ-MnO₂ can be 100% or more, 150% or more, 200% or more, 250% or more, and/or 300% or less than the cumulative pore volume of the corresponding precursor spinel. In some embodiments, the average pore size of a λ-MnO₂ can be comparable to the average pore size of the corresponding precursor spinel or even somewhat larger (e.g., 1 to 5% larger). In some embodiments, a λ-MnO₂ can have a cumulative pore volume of 0.03 cm³/g or more, 0.06 cm³/g or more, 0.09 cm³/g or more, 0.1 cm³/g or more, and/or 0.15 cm³/g or less; and an average pore size of 15 angstroms or more, 20 angstroms or more, 25 angstroms or more, 30 angstroms or more, 35 angstroms or more, 40 angstroms or more, and/or 45 angstroms or less. For comparison, the cumulative desorption pore volume of a typical commercial EMD (γ-MnO₂) is about 0.07 to 0.08 cm²/g with an average pore size of about 35 to 40 angstroms.

Mean particle sizes and particle size distributions for λ-MnO₂ powders and corresponding precursor spinel powders can be determined by a laser diffraction particle size analyzer (e.g., a SympaTec Helos particle size analyzer equipped with a Rodos dry powder dispensing unit) using Fraunhofer or Mie theory algorithms to compute the volume distribution of particle sizes and mean particle sizes as described, for example, by M. Puckhaber and S. Rothele (Powder Handling & Processing, 1999, 11(1), 91-95; European Cement Magazine, 2000, 18-21). Typically, the precursor spinel and λ-MnO₂ powders consist of loose agglomerates or sintered aggregates (i.e., secondary particles) composed of much smaller primary particles. Such agglomerates and aggregrates are readily measured by a particle size analyzer. The primary particles can be determined by microscopy (e.g., scanning electron microscopy, transmission electron microscopy). For example, a nominally stoichiometric lithium manganese oxide spinel powder can have a mean particle size (i.e., D₅₀) of 3 microns or more, 10 microns or more, 20 microns or more, and/or 30 microns or less, 20 microns or less, 10 microns or less, or 5 microns or less; and a particle size distribution ranging from 2 to 30 microns, from 5 to 25 microns, from 7 to 20 microns, or from 12 to 20 microns. As an example, a λ-MnO₂ can have a mean particle size (i.e., D₅₀) of 2 microns or more, 5 microns or more, 10 microns or more, 20 microns or more and/or 30 microns or less, 20 microns or less, 10 microns or less, 5 microns or less; and a particle size distribution ranging from 1 to 30 microns, from 3 to 25 microns, from 5 to 20 microns, or from 10 to 15 microns. As a further example, based on SEM analysis of individual agglomerates or aggregates, λ-MnO₂ can have a primary particle size of 0.25 microns or more, 0.5 microns or more, 0.75 microns or more, 1.0 microns or more, and/or 2 microns or less, 1.0 micron or less, 0.5 microns or less. An agglomerate or aggregate particle can include an assemblage of the primary particles.

In some embodiments, true (or real) densities for the λ-MnO₂ powders and corresponding precursor spinel powders can be measured with a He gas pycnometer (e.g., Quantachrome Ultrapyc Model 1200e) as described in general by P. A. Webb (“Volume and Density Determinations for Particle Technologists”, Internal Report, Micromeritics Instrument Corp., 2001, pp. 8-9) using a standard test method, for example, ASTM Standard D5965-02 (“Standard Test Methods for Specific Gravity of Coating Powders”, ASTM International, West Conshohocken, Pa., 2007) or ASTM Standard B923-02 (“Standard Test Method for Metal Powder Skeletal Density by Helium or Nitrogen Pycnometry”, ASTM International, West Conshohocken, Pa., 2008). True density is defined, for example, by the British Standards Institute, as the mass of a particle divided by its volume, excluding open pores and closed pores. For example, nominally stoichiometric lithium manganese oxide spinel powder can have a true density of 3.90 g/cm³ or more, 4.00 g/cm³ or more, 4.10 g/cm³ or more, 4.20 g/cm³ or more, or 4.25 g/cm³ or more. A λ-MnO₂ prepared from a spinel by low temperature acid extraction can have a true density of 4.10 g/cm³ or more, 4.20 g/cm³ or more, 4.30 g/cm³ or more, 4.40 g/cm³ or more. For comparison, the true density of a typical commercial EMD is about 4.45-4.50 g/cm³.

In some embodiments, elemental compositions of the λ-MnO₂ powders and the corresponding precursor spinel powders can be determined by inductively coupled plasma atomic emission spectroscopy (ICP-AES) and/or by atomic absorption spectroscopy (AA) using standard methods as described in general, for example, by J. R. Dean (Practical Inductively Coupled Plasma Spectroscopy, Chichester, England: Wiley, 2005, 65-87) and B. Welz & M. B. Sperling (Atomic Absorption Spectrometry, 3^{rd} ed., Weinheim, Germany: Wiley VCH, 1999, 221-294). Average oxidation state of Mn in the λ-MnO₂ and the corresponding precursor spinel can be determined by chemical titrimetry using ferrous ammonium sulfate and standardized potassium permanganate solutions as described, for example by A. F. Dagget and W. B. Meldrun (Quantitative Analysis, Boston: Heath, 1955, 408-409). For example, Li/Mn atom ratios can be determined for the precursor spinel powders and the residual Li contents (i.e., wt % Li) for the corresponding λ-MnO₂ powders. The Li/Mn atom ratios for a nominally stoichiometric precursor spinel powder can range between about 0.6 and 0.8, corresponding to x values of −0.1≦x≦+0.1 in the general formula Li₁₊ₓMn₂₋ₓO₄ with Li weight percentage values ranging between about 3.4% and 4.3%. Desirably, the residual (i.e., un-extracted) Li content for essentially Li-free λ-MnO₂ can be less than 1 wt % Li, less than 0.5 wt % Li, less than 0.3 wt % Li, less than 0.2 wt % Li, or less than 0.1 wt % Li. Li/Mn ratios for essentially Li-free λ-MnO₂ can desirably range between about 0.01 and 0.05.

Incorporation into a Battery

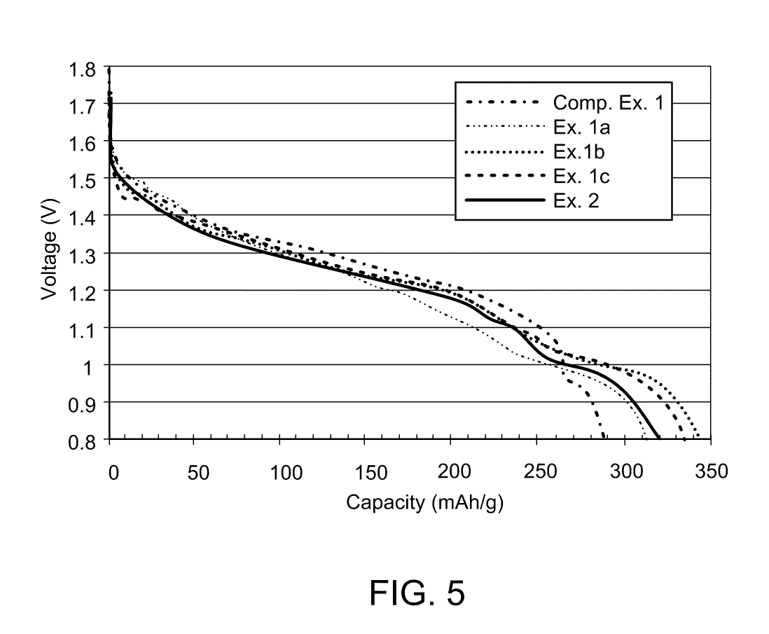

Without wishing to be bound by theory, it is believed that when λ-MnO₂ is incorporated into the cathode of an alkaline battery 10, the λ-MnO₂ can undergo a multi-electron reduction during discharge. For example, λ-MnO₂ can undergo a total reduction of 1.33 electron/Mn accompanied by transformation of the cubic spinel lattice of λ-MnO₂ including only Mn⁴⁺ to another spinel phase that can be identified by X-ray powder diffraction as hausmannite (Mn₃O₄) (i.e., Powder Diffraction File No. 24-0734; International Centre for Diffraction Data, Newtown Square, Pa.) including mixed valence Mn^{3+,2+} as given by Equation 5. It is further hypothesized that the additional capacity appearing on a flat plateau having an average voltage of about 1 V in the typical discharge curve of an alkaline cell with a cathode including the λ-MnO₂ shown, for example, in FIG. 5 can be attributed to reduction (i.e., 0.33 electron/Mn) of a putative protonated, spinel-related intermediate phase, for example, “H₂Mn₂O₄” by a heterogeneous conversion reaction to form the final discharge product, hausmannite (Mn₃O₄).

3λ-Mn⁴⁺₂O₄+4H₂O→2Mn₂³⁺Mn²⁺O₄+8OH⁻ (5)

Discharge performance of several examples of λ-MnO₂ prepared by delithiation methods of prior art is described, for example, by Xia et al., (Dianyuan Jishu, 1999, 23(Suppl.), 74-76); O, Schilling et al., (ITE Letters on Batteries, 2001, 2(3), B24-31); and also disclosed in U.S. Pat. No. 6,783,893.

In some embodiments, an alkaline battery 10 having cathode 12 including a λ-MnO₂ prepared by low temperature acid extraction of a nominally stoichiometric lithium manganese oxide spinel chemically prepared from a small particle CMD-type precursor as the active material can have substantially improved discharge performance compared to a battery with a cathode including λ-MnO₂ prepared from a commercial spinel by a method of prior art. For example, battery 10 can have a gravimetric specific capacity of 300 mAh/g or more, 320 mAh/g or more, 330 mAh/g or more, 350 mAh/g or more, 370 mAh/g or more, and/or 400 mAh/g or less at a relatively low discharge rate (e.g., about C/35, 10 mA/g) to a cutoff voltage of 0.8 V. The gravimetric capacity can be 10 to 30% greater than batteries with cathodes including either a commercial EMD or a λ-MnO₂ prepared from a commercial spinel by methods of prior art. Battery 10 with a cathode including λ-MnO₂ prepared by the low temperature acid extraction process of the invention can have an open circuit voltage (OCV) of 1.75 V or less, 1.70 V or less, or 1.65 V or less. Battery 10 also can have an average discharge voltage of 1.15 V or more, 1.20 V or more, 1.25 V or more, or 1.30 V or more when discharged at a relatively low discharge rate (e.g., about C/40, ˜10 mA/g) to a cutoff voltage of 0.8 V. Typically, average voltage is measured at 50% depth of discharge (DOD) of the battery.

In some embodiments, prior to incorporation into a battery, a dry mixture of λ-MnO₂ and an oxidation-resistant graphite (e.g., Timcal-America, Timrex® SFG-15) can be subjected to a high-energy milling treatment. Without wishing to be bound by theory, it is believed that during the high-energy milling treatment, the surface of the λ-MnO₂ particles can be coated with graphite, resulting in decreased cathode resistivity as well as partial reduction of Mn⁴⁺ on the surface of the λ-MnO₂ particles, which can cause a decrease in OCV of a battery including λ-MnO₂, for example, from an OCV value of about 1.85 V before treatment to a value of about 1.65 V after treatment.

Cathode 12 can include λ-MnO₂, and can further include an electrically conductive additive and optionally a binder. In some embodiments, cathode 12 can include a blend of cathode active materials including λ-MnO₂ and one or more additional cathode active materials. As used herein, a blend refers to a physical mixture of two or more cathode active materials, where the particles of the two or more cathode materials are physically (e.g., mechanically) interspersed to form a nominally homogeneous assemblage of particles on a macroscopic scale, wherein each type of particle retains its original chemical composition. Blends of λ-MnO₂ and a second cathode active material are disclosed, for example, in Attorney Docket No. 08935-0416001, filed concurrently with the present application.

In some embodiments, cathode 12 can include, for example, between 60% and 97%, between 80% and 95%, between 85% and 90% by weight a cathode active material (e.g., λ-MnO₂ or a blend including λ-MnO₂ and a second active material) relative to the total weight of the cathode. For example, the second active cathode material can be EMD as disclosed in U.S. Pat. No. 7,045,252. The cathode can include between 3% and 35%, between 4% and 20%, between 5% and 10%, or between 6% and 8% by weight of an electrically conductive additive; and 0.05% or more by weight and/or 5% or less by weight of a binder (e.g., a polymeric binder). Some electrolyte solution also can be dispersed throughout cathode 12 and the amount added can range from about 1% to 7% by weight. All weight percentages relating to cathode 12 include the weight of the dispersed electrolyte in the total cathode weight (i.e., “wet” weight).

In some embodiments, to enhance bulk electrical conductivity and stability of the cathode, particles of the cathode active materials can include an electrically conductive surface coating. Increasing electrical conductivity of the cathode can enhance total discharge capacity and/or average running voltage of battery 10 (e.g., at low discharge rates), as well as enhance the effective cathode utilization (e.g., at high discharge rates). The conductive surface coating can include a carbonaceous material, such as a natural or synthetic graphite, a carbon black, a partially graphitized carbon black, and/or an acetylene black. The conductive surface coating can include a metal, such as gold or silver and/or a conductive or semiconductive metal oxide, such as cobalt oxide (e.g., CO₃O₄), cobalt oxyhydroxide, silver oxide, antimony-doped tin oxide, zinc antimonate or indium tin oxide. The surface coating can be applied or deposited, for example, using solution techniques including electrodeposition, electroless deposition, by vapor phase deposition (e.g., sputtering, physical vapor deposition, or chemical vapor deposition) or by direct coating conductive particles to the surface of the active particles using a binder and/or coupling agent as described, for example by J. Kim et al. (Journal of Power Sources, 2005, 139, 289-294) and R. Dominko et al. (Electrochemical and Solid State Letters, 2001, 4(11), A187-A190). A suitable conductive coating thickness can be provided by applying the conductive surface coating at between 3 and 10 percent by weight (e.g., greater than or equal to 3, 4, 5, 6, 7, 8, or 9 percent by weight, and/or less than or equal to 10, 9, 8, 7, 6, 5, or 4 percent by weight) relative to the total weight of the cathode active material.

In addition, as indicated above, cathode 12 can include an electrically conductive additive capable of enhancing the bulk electrical conductivity of cathode 12. The conductive additive can be blended with one or more cathode active materials prior to fabrication of cathode 12. Examples of conductive additives include graphite, carbon black, silver powder, gold powder, nickel powder, carbon fibers, carbon nanofibers, and/or carbon nanotubes. Preferred conductive additives include graphite particles, graphitized carbon black particles, carbon nanofibers, vapor phase grown carbon fibers, and single and multiwall carbon nanotubes. In certain embodiments, the graphite particles can be non-synthetic (i.e., “natural”), nonexpanded graphite particles, for example, MP-0702X available from Nacional de Grafite (Itapecirica, Brazil) and FormulaBT™ grade available from Superior Graphite Co. (Chicago, Ill.). In other embodiments, the graphite particles can be expanded natural or synthetic graphite particles, for example, Timrex® BNB90 available from Timcal, Ltd. (Bodio, Switzerland), WH20 or WH20A grade from Chuetsu Graphite Works Co., Ltd. (Osaka, Japan), and ABG grade available from Superior Graphite Co. (Chicago, Ill.). In yet other embodiments, the graphite particles can be synthetic, non-expanded graphite particles, for example, Timrex® KS4, KS6, KS15, MX15 available from Timcal, Ltd. (Bodio, Switzerland). The graphite particles can be oxidation-resistant synthetic, non-expanded graphite particles. The term “oxidation resistant graphite” as used herein refers to a synthetic graphite made from high purity carbon or carbonaceous materials having a highly crystalline structure. The use of oxidation resistant graphite in blends with λ-MnO₂ can reduce the rate of graphite oxidation by λ-MnO₂. As evidenced by its higher OCV, λ-MnO₂ is a more strongly oxidizing active material than EMD. Suitable oxidation resistant graphites include, for example, SFG4, SFG6, SFG10, SFG15 available from Timcal, Ltd., (Bodio, Switzerland). The use of oxidation resistant graphite in blends with another strongly oxidizing cathode active material, nickel oxyhydroxide, is disclosed in commonly assigned U.S. Ser. No. 11/820,781, filed Jun. 20, 2007. Carbon nanofibers are described, for example, in commonly-assigned U.S. Ser. No. 09/658,042, filed Sep. 7, 2000 and U.S. Ser. No. 09/829,709, filed Apr. 10, 2001. Cathode 12 can include between 3% and 35%, between 4% and 20%, between 5% and 10%, or between 6% and 8% by weight of conductive additive.

An optional binder can be added to cathode 12 to enhance structural integrity. Examples of binders include polymers such as polyethylene powders, polypropylene powders, polyacrylamides, and various fluorocarbon resins, for example polyvinylidene difluoride (PVDF) and polytetrafluoroethylene (PTFE). An example of a suitable polyethylene binder is available from Dupont Polymer Powders (Sari, Switzerland) under the tradename Coathylene HX1681. The cathode 12 can include, for example, from 0.05% to 5% or from 0.1% to 2% by weight binder relative to the total weight of the cathode. Cathode 12 can also include other optional additives.

In some embodiments, when incorporated into an alkaline electrochemical cell, cathodes including λ-MnO₂ can generate soluble manganate ions (i.e., [Mn⁶⁺O₄]²⁻) and/or permanganate ions (i.e., [Mn⁷⁺O₄]⁻), for example, when placed into contact with a KOH-containing electrolyte solution. Without wishing to be bound by theory, it is believed that soluble manganate ([Mn⁶⁺O₄]²⁻) ions and/or permanganate ([Mn⁷⁺O₄]⁻) ions can be formed along with Mn²⁺ ions in a Mn⁶⁺/Mn²⁺ mole ratio of 1 by disproportionation of Mn⁴⁺ ions on the surface of the λ-MnO₂ particles in contact with a strongly alkaline (i.e., pH≧14) electrolyte solution according to Equation 6.

2Mn⁴⁺O₂4OH⁻→[Mn⁶⁺O₄]²⁻+[Mn²⁺(OH)₄]²⁻ (6)

Formation of manganate and permanganate ions by EMD powders that had been treated with an aqueous acid solution (e.g., 9-10 M H₂SO₄) at 80° C. to 95° C. for several hours, washed thoroughly with water, and then placed in contact with a KOH electrolyte solution (e.g., 0.1-9 M KOH) has been described by A. Kozawa (Journal of the Electrochemical Society of Japan, 1976, 44(8), 508-513). It was hypothesized that formation of manganate and permanganate ions occurred because the potential (i.e., OCV) of the acid-treated EMD was increased relative to untreated EMD such that in high pH solutions (e.g., pH 14), the solid MnO₂ phase was no longer thermodynamically stable relative to formation of soluble manganate and/or permanganate ions and Mn²⁺ ions. This situation is depicted in the equilibrium pH-potential diagram for Mn—H₂O at 25° C. as presented by M. J. N. Pourbaix (Atlas of Electrochemical Equilibriums in Aqueous Solutions, 2^{nd} ed., 1974, Houston, Tex.: National Association of Corrosion Engineers). It is further believed that the presence of manganate ions dissolved in the electrolyte of an alkaline cell can decrease hydrogen gassing by the zinc anode and thereby improve capacity retention during storage compared to a cell that does not include manganate ions dissolved in the electrolyte. An additional amount (e.g., <5 wt %) of a soluble manganate salt, for example, barium manganate, silver manganate, and/or copper manganate can be optionally added to the cathode in addition to the λ-MnO₂ or substituted for a portion of the λ-MnO₂.

The electrolyte solution can be any of the electrolyte solutions commonly used in alkaline batteries. The electrolyte solution can be an aqueous solution of an alkali metal hydroxide such as KOH, NaOH, or a mixture of alkali metal hydroxides, for example, KOH and NaOH. However, the electrolyte solution should not contain an appreciable concentration of Li ions because Li ions can undergo preferential insertion into the λ-MnO₂ lattice relative to protons as discussed by X. Shen & A. Clearfield (Journal of Solid State Chemistry, 1986, 64, 270-282) and K. Ooi et al. (Chemistry Letters, 1988, 989-992). For example, the aqueous alkali metal hydroxide solution can include between about 20 percent and 55 percent, between about 30 percent and 50 percent, between about 33 and about 45 percent by weight of the alkali metal hydroxide, for example, about 37% by weight KOH (i.e., about 9 M KOH). In some embodiments, the electrolyte solution also can include from 0 percent to 6 percent by weight of a metal oxide, such as zinc oxide, for example, about 2 percent by weight zinc oxide.

Anode 14 can be formed of any of the zinc-based materials conventionally used in alkaline battery zinc anodes. For example, anode 14 can be a gelled zinc anode that includes zinc metal particles and/or zinc alloy particles, a gelling agent, and minor amounts of additives, such as a gassing inhibitor. A portion of the electrolyte solution can be dispersed throughout the anode. The zinc particles can be any of the zinc-based particles conventionally used in gelled zinc anodes. The zinc-based particles can be formed of a zinc-based material, for example, zinc or a zinc alloy. Generally, a zinc-based particle formed of a zinc-alloy is greater than 75% zinc by weight, typically greater than 99.9% by weight zinc. The zinc alloy can include zinc (Zn) and at least one of the following elements: indium (In), bismuth (Bi), aluminum (Al), calcium (Ca), gallium (Ga), lithium (Li), magnesium (Mg), and tin (Sn). The zinc alloy typically is composed primarily of zinc and preferably can include metals that can inhibit gassing, such as indium, bismuth, aluminum and mixtures thereof. As used herein, gassing refers to the evolution of hydrogen gas resulting from a reaction of zinc metal or zinc alloy with the electrolyte. The presence of hydrogen gas inside a sealed battery is undesirable because a pressure buildup can cause leakage of electrolyte. Preferred zinc-based particles are both essentially mercury-free and lead-free. Examples of zinc-based particles include those described in U.S. Pat. Nos. 6,284,410; 6,472,103; 6,521,378; and commonly-assigned U.S. application Ser. No. 11/001,693, filed Dec. 1, 2004, all hereby incorporated by reference. The terms “zinc”, “zinc powder”, or “zinc-based particle” as used herein shall be understood to include zinc alloy powder having a high relative concentration of zinc and as such functions electrochemically essentially as pure zinc. The anode can include, for example, between about 60% and about 80%, between about 62% and 75%, between about 63% and about 72%, or between about 67% and about 71% by weight of zinc-based particles. For example, the anode can include less than about 72%, about 70%, about 68%, about 64%, or about 60%, by weight zinc-based particles.

The zinc-based particles can be formed by various spun or air blown processes. The zinc-based particles can be spherical or non-spherical in shape. Non-spherical particles can be acicular in shape (i.e., having a length along a major axis at least two times a length along a minor axis) or flake-like in shape (i.e., having a thickness not more than 20% of the length of the maximum linear dimension). The surfaces of the zinc-based particles can be smooth or rough. As used herein, a “zinc-based particle” refers to a single or primary particle of a zinc-based material rather than an agglomeration or aggregation of more than one particle. A percentage of the zinc-based particles can be zinc fines. As used herein, zinc fines include zinc-based particles small enough to pass through a sieve of 200 mesh size (i.e., a sieve having a Tyler standard mesh size corresponding to a U.S. Standard sieve having square openings of 0.075 mm on a side) during a normal sieving operation (i.e., with the sieve shaken manually). Zinc fines capable of passing through a 200 mesh sieve can have a mean average particle size from about 1 to 75 microns, for example, about 75 microns. The percentage of zinc fines (i.e., −200 mesh) can make up about 10 percent, 25 percent, 50 percent, 75 percent, 80 percent, 90 percent, 95 percent, 99 percent or 100 percent by weight of the total zinc-based particles. A percentage of the zinc-based particles can be zinc dust small enough to pass through a 325 mesh size sieve (i.e., a sieve having a Tyler standard mesh size corresponding to a U.S. Standard sieve having square openings of 0.045 mm on a side) during a normal sieving operation. Zinc dust capable of passing through a 325 mesh sieve can have a mean average particle size from about 1 to 35 microns (for example, about 35 microns). The percentage of zinc dust can make up about 10 percent, 25 percent, 50 percent, 75 percent, 80 percent, 90 percent, 95 percent, 99 percent or 100 percent by weight of the total zinc-based particles. Even very small amounts of zinc fines, for example, at least about 5 weight percent, or at least about 1 weight percent of the total zinc-based particles can have a beneficial effect on anode performance. The total zinc-based particles in the anode can consist of only zinc fines, of no zinc fines, or mixtures of zinc fines and dust (e.g., from about 35 to about 75 weight percent) along with larger size (e.g., −20 to +200 mesh) zinc-based particles. A mixture of zinc-based particles can provide good overall performance with respect to rate capability of the anode for a broad spectrum of discharge rate requirements as well as provide good storage characteristics. To improve performance at high discharge rates after storage, a substantial percentage of zinc fines and/or zinc dust can be included in the anode.

Anode 14 can include gelling agents, for example, a high molecular weight polymer that can provide a network to suspend the zinc particles in the electrolyte. Examples of gelling agents include polyacrylic acids, grafted starch materials, salts of polyacrylic acids, polyacrylates, carboxymethylcellulose, a salt of a carboxymethylcellulose (e.g., sodium carboxymethylcellulose) or combinations thereof. Examples of polyacrylic acids include Carbopol 940 and 934 available from B.F. Goodrich Corp. and Polygel 4P available from 3V. An example of a grafted starch material is Waterlock A221 or A220 available from Grain Processing Corp. (Muscatine, Iowa). An example of a salt of a polyacrylic acid is Alcosorb G1 available from Ciba Specialties. The anode can include, for example, between about 0.05% and 2% by weight or between about 0.1% and 1% by weight of the gelling agent by weight.

Gassing inhibitors can include a metal, such as bismuth, tin, indium, aluminum or a mixture or alloys thereof. A gassing inhibitor also can include an inorganic compound, such as a metal salt, for example, an indium or bismuth salt (e.g., indium sulfate, indium chloride, bismuth nitrate). Alternatively, gassing inhibitors can be organic compounds, such as phosphate esters, ionic surfactants or nonionic surfactants. Examples of ionic surfactants are disclosed in, for example, U.S. Pat. No. 4,777,100, which is hereby incorporated by reference.

Separator 16 can have any of the conventional designs for primary alkaline battery separators. In some embodiments, separator 16 can be formed of two layers of a non-woven, non-membrane material with one layer being disposed along a surface of the other. To minimize the volume of separator 16 while providing an efficient battery, each layer of non-woven, non-membrane material can have a basic weight of about 54 grams per square meter, a thickness of about 5.4 mils when dry and a thickness of about 10 mils when wet. In these embodiments, the separator preferably does not include a layer of membrane material or a layer of adhesive between the non-woven, non-membrane layers. Typically, the layers can be substantially devoid of fillers, such as inorganic particles. In some embodiments, the separator can include inorganic particles. In other embodiments, separator 16 can include a layer of cellophane combined with a layer of non-woven material. The separator optionally can include an additional layer of non-woven material. The cellophane layer can be adjacent to cathode 12. Preferably, the non-woven material can contain from about 78% to 82% by weight polyvinylalcohol (PVA) and from about 18% to 22% by weight rayon and a trace amount of surfactant. Such non-woven materials are available from PDM under the tradename PA25. An example of a separator including a layer of cellophane laminated to one or more layers of a non-woven material is Duralam DT225 available from Duracell Inc. (Aarschot, Belgium).

In yet other embodiments, separator 16 can be an ion-selective separator. An ion-selective separator can include a microporous membrane with an ion-selective polymeric coating. In some cases, such as in rechargeable alkaline manganese dioxide cells, diffusion of soluble zincate ion, i.e., [Zn(OH)₄]²⁻, from the anode to the cathode can interfere with the reduction and oxidation of manganese dioxide, thereby resulting in a loss of coulombic efficiency and ultimately in decreased cycle life. Separators that can selectively inhibit the passage of zincate ions, while allowing free passage of hydroxide ions are described in U.S. Pat. Nos. 5,798,180 and 5,910,366. An example of a separator includes a polymeric substrate having a wettable cellulose acetate-coated polypropylene microporous membrane (e.g., Celgard® 3559, Celgard® 5550, Celgard® 2500, and the like) and an ion-selective coating applied to at least one surface of the substrate. Suitable ion-selective coatings include polyaromatic ethers (such as a sulfonated derivative of poly(2,6-dimethyl-1,4-phenyleneoxide)) having a finite number of recurring monomeric phenylene units each of which can be substituted with one or more lower alkyl or phenyl groups and a sulfonic acid or carboxylic acid group. In addition to preventing migration of zincate ions to the manganese dioxide cathode, the selective separator was described in U.S. Pat. Nos. 5,798,180 and 5,910,366 as capable of diminishing diffusion of soluble ionic species away from the cathode during discharge.

Alternatively or in addition, the separator can prevent substantial diffusion of soluble transition metal species (e.g., Ag⁺, Ag²⁺, Cu⁺, Cu²⁺, Bi⁵⁺, and/or Bi³⁺) away from the cathode to the zinc anode, such as the separator described in U.S. Pat. No. 5,952,124. The separator can include a substrate membrane such as cellophane, nylon (e.g., Pellon® sold by Freundenburg, Inc.), microporous polypropylene (e.g., Celgard® 3559 sold by Celgard, Inc.) or a composite material including a dispersion of a carboxylic ion-exchange material in a microporous acrylic copolymer (e.g., PD2193 sold by Pall-RAI, Inc.). The separator can further include a polymeric coating thereon including a sulfonated polyaromatic ether, as described in U.S. Pat. Nos. 5,798,180; 5,910,366; and 5,952,124.

In other embodiments, separator 16 can include an adsorptive or trapping layer. Such a layer can include inorganic particles that can form an insoluble compound or an insoluble complex with soluble transition metal species to limit diffusion of the soluble transition metal species through the separator to the anode. The inorganic particles can include metal oxide nanoparticles, for example, as ZrO₂ and TiO₂. Although such an adsorptive separator can attenuate the concentration of the soluble transition metal species, it may become saturated and lose effectiveness when high concentrations of soluble bismuth species are adsorbed. An example of such an adsorptive separator is disclosed in commonly assigned U.S. Ser. No. 10/682,740, filed on Oct. 9, 2003.

Battery housing 18 can be any conventional housing commonly used for primary alkaline batteries. The battery housing 18 can be fabricated from metal, for example, nickel-plated cold-rolled steel. The housing typically includes an inner electrically-conductive metal wall and an outer electrically non-conductive material such as heat shrinkable plastic. An additional layer of conductive material can be disposed between the inner wall of the battery housing 18 and cathode 12. This layer may be disposed along the inner surface of the wall, along the circumference of cathode 12 or both. This conductive layer can be applied to the inner wall of the battery, for example, as a paint or dispersion including a carbonaceous material, a polymeric binder, and one or more solvents. The carbonaceous material can be carbon particles, for example, carbon black, partially graphitized carbon black or graphite particles. Such materials include LB1000 (Timcal, Ltd.), Eccocoat 257 (W. R. Grace & Co.), Electrodag 109 (Acheson Colloids, Co.), Electrodag 112 (Acheson), and EB0005 (Acheson). Methods of applying the conductive layer are disclosed in, for example, Canadian Patent No. 1,263,697, which is hereby incorporated by reference.

The anode current collector 20 passes through seal 22 extending into anode 14. Current collector 20 is made from a suitable metal, such as brass or brass-plated steel. The upper end of current collector 20 electrically contacts the negative top cap 24. Seal 22 can be made, for example, of nylon.

Battery 10 can be assembled using conventional methods and hermetically sealed by a mechanical crimping process. In some embodiments, positive electrode 12 can be formed by a pack and drill method, described in U.S. Ser. No. 09/645,632, filed Aug. 24, 2000.

Battery 10 can be a primary electrochemical cell or in some embodiments, a secondary electrochemical cell. Primary batteries are meant to be discharged (e.g., to exhaustion) only once, and then discarded. In other words, primary batteries are not intended to be recharged. Primary batteries are described, for example, by D. Linden and T. B. Reddy (Handbook of Batteries, 3^{rd} ed., New York: McGraw-Hill Co., Inc., 2002). In contrast, secondary batteries can be recharged for many times (e.g., more than fifty times, more than a hundred times, more than a thousand times). In some cases, secondary batteries can include relatively robust separators, such as those having many layers and/or that are relatively thick. Secondary batteries can also be designed to accommodate changes, such as swelling, that can occur in the batteries. Secondary batteries are described, for example, by T. R. Crompton (Battery Reference Book, 3^{rd} ed., Oxford: Reed Educational and Professional Publishing, Ltd., 2000) and D. Linden and T. B. Reddy (Handbook of Batteries, 3^{rd} ed., New York: McGraw-Hill Co., Inc., 2002).

Battery 10 can have any of a number of different nominal discharge voltages (e.g., 1.2 V, 1.5 V, 1.65 V), and/or can be, for example, a AA, AAA, AAAA, C, or D battery. While battery 10 can be cylindrical, in some embodiments, battery 10 can be non-cylindrical. For example, battery 10 can be a coin cell, a button cell, a wafer cell, or a racetrack-shaped cell. In some embodiments, a battery can be prismatic. In certain embodiments, a battery can have a rigid laminar cell configuration or a flexible pouch, envelope or bag cell configuration. In some embodiments, a battery can have a spirally wound configuration, or a flat plate configuration. Batteries are described, for example, in U.S. Pat. No. 6,783,893; U.S. Patent Application Publication No. 2007/0248879 A1, filed on Jun. 20, 2007; and U.S. Pat. No. 7,435,395.

### EXAMPLES

The following examples are illustrative and not intended to be limiting.

### Example 1

### Synthesis of λ-MnO₂ from a Commercial Lithium Manganese Oxide Spinel

A high purity λ-MnO₂ was prepared from a nominally stoichiometric lithium manganese oxide spinel powder obtained from a commercial source by low temperature acid extraction to remove essentially all the lithium from the spinel crystal lattice. Such a spinel having a nominal chemical formula of Li_{0.98}Mn_{2.02}O₄ was obtained for example, from Erachem-Comilog, Inc. (Baltimore, Md.) under the tradename P300. Values for measured physicochemical properties of the precursor spinel are summarized in Table 1.

### Example 1a

Approximately 100 g of dry spinel powder was added with stirring to about 1.5 liters of 6 M sulfuric acid solution pre-cooled to about 2° C. to form a slurry. This slurry was stirred for a period ranging from 12 to 20 hours and maintained at between 2° C. and 5° C. The stirring was stopped, the solids allowed to settle, and the supernatant solution removed by decantation and discarded. A 1.5 to 2 liter portion of deionized water was added to the solid deposit and the mixture stirred for at least 1 to 5 minutes at ambient room temperature. The solids were allowed to settle, the supernatant removed by decantation, and the pH of the supernatant measured. If the pH of the supernatant was less than about 6 to 7, the water washing process was repeated. Once the pH of the supernatant was in the range of 6 to 7, a solid product was isolated by filtration (i.e., suction filtration, pressure filtration), centrifugation or spray drying. The solid product was dried at 60° C. in air for about 12 to 24 hours. The weight of the dried solid product typically ranged from about 70 to 75 g, corresponding to a weight loss of about 25 to 30% relative to the weight of the starting spinel.

The X-ray powder diffraction pattern of the dried product was nearly identical to the standard diffraction pattern reported for λ-MnO₂ (i.e., Powder Diffraction File No. 44-0992; International Centre for Diffraction Data, Newtown Square, Pa.). The value of the refined cubic unit cell constant a₀=8.04929 Å was calculated from the powder diffraction data by Reitveld structural refinement analysis and is consistent with typical values reported in the literature for λ-MnO₂ ranging from 8.0222 Å to 8.0640 Å. The X-ray crystallite size of the λ-MnO₂ calculated by the Scherrer method was about 72 nm compared to 101 nm for the precursor spinel. The value of 15.8 m²/g for the multipoint N₂-adsorption B.E.T. specific surface area for the λ-MnO₂ powder was substantially larger than the value of 5.8 m²/g for the precursor spinel powder. The average particle size (i.e., D₅₀) decreased from about 4.1 microns for the precursor spinel powder to about 3.0 microns for the λ-MnO₂ powder. The λ-MnO₂ powder had a true density (i.e., He pycnometer density) of about 4.18 g/cm³ and a tap density of about 1.10 g/cm³. The corresponding values for the precursor spinel were about 4.01 g/cm³ and about 0.95-1.00 g/cm³. The residual lithium content of the λ-MnO₂ was determined by AA spectroscopy to be 0.339 wt % and the manganese content determined by ICP-AE spectroscopy to be 64.8 wt %, corresponding to a calculated chemical formula of about Li_{0.041}MnO₂. Values for measured physicochemical properties of the λ-MnO₂ of Example 1a are summarized in Table 2A.

### Example 1b

In order to remove residual lithium remaining in the λ-MnO₂ crystal lattice after the first acid extraction process, the dried λ-MnO₂ of Example 1a was lightly ground, for example, manually with a mortar and pestle, and the resulting powder added with stirring to about 1.5 liters of 6 M sulfuric acid solution pre-cooled to about 2° C. The acid extraction process was repeated as in Example 1a. The weight of the dried solid product was only slightly less than the starting weight of λ-MnO₂. The residual lithium content of the twice acid-extracted λ-MnO₂ decreased to 0.197 wt % and the manganese content was 61.4 wt %, corresponding to a calculated chemical formula of Li_{0.025}MnO₂. The X-ray powder diffraction pattern of the twice acid-extracted λ-MnO₂ of Example 1b was nearly identical to that of the λ-MnO₂ of Example 1a. The value of the refined cubic unit cell constant decreased slightly to a₀=8.04372 Å. The X-ray crystallite size of the λ-MnO₂ of Example 1b calculated by the Scherrer method was about 74 nm, nearly the same as that of the λ-MnO₂ of Example 1a. The B.E.T. specific surface area of the λ-MnO₂ powder of Example 1b increased by nearly 50% to about 24.1 m²/g, whereas the average particle size only decreased slightly to a value of about 2.9 microns. The λ-MnO₂ powder had a true density (i.e., He pycnometer density) of about 4.21 g/cm³ and a tap density of about 1.10 g/cm³. Values for measured physicochemical properties of the λ-MnO₂ of Example 1b are summarized in Table 2A.

### Example 1c

In order to remove essentially all the residual lithium from the λ-MnO₂ of Example 1b, the dried twice acid-extracted λ-MnO₂ powder was acid-extracted a third time using the acid extraction process of Example 1a. The weight of the dried triply acid-extracted λ-MnO₂ powder was essentially the same as the starting weight less solids transfer losses. The residual lithium content of the triply acid-extracted λ-MnO₂ of Example 1c decreased slightly to a value of 0.136 wt % and the manganese content was 61.0 wt %, corresponding to a calculated chemical formula of about Li_{0.017}MnO₂. The X-ray powder diffraction pattern of the λ-MnO₂ of Example 1c was essentially identical to that of the λ-MnO₂ of Example 1a and had a similar refined cubic unit cell constant value of a₀=8.04389 Å. The X-ray crystallite size of the λ-MnO₂ of Example 1c calculated by the Scherrer method was the same as that of the λ-MnO₂ of Example 1a. Both the B.E.T. specific surface area and average particle size (i.e., D₅₀) of the λ-MnO₂ powder of Example 1c were essentially unchanged from those of the λ-MnO₂ powder of Example 1b. Values for measured physicochemical properties of the λ-MnO₂ of Example 1c are summarized in Table 2A.

The discharge performance of the λ-MnO₂ powders of Examples 1a, 1b, and 1c was evaluated in 635-type alkaline button cells. Cells were assembled in the following manner. A 10 g portion of the dried λ-MnO₂ powder was blended together with an oxidation-resistant synthetic graphite, for example, Timrex® SFG15 available from Timcal, Ltd. (Bodio, Switzerland) and a KOH electrolyte solution containing 38 wt % KOH and 2 wt % zinc oxide in a weight ratio of 75:20:5 to form a wet cathode mix. About 0.3-0.4 g of the wet cathode mix was pressed into a nickel grid welded to the bottom of the cathode can. A polymeric insulating seal was inserted into the cathode can. A disk of multilayer separator including a layer of cellophane bonded to a non-woven polymeric layer, for example, Duralam® DT225 from Duracell, Inc. (Aarshot, Belgium) was saturated with electrolyte solution and positioned on top the cathode with the cellophane layer facing the cathode. Additional electrolyte solution was added to the separator to ensure that the underlying cathode also was saturated. About 2.6 g of anode slurry containing zinc-based particles, electrolyte solution, a gelling agent, and a gassing inhibitor was applied to the upper surface of the separator. The anode can was positioned on top the cell assembly and was mechanically crimped to the cathode can with the interposed seal to hermetically close the cell.

Typically, cells were tested within 24 hours after fabrication. OCV values were measured immediately before discharge (i.e., “fresh”) and are given in Table 3. Cells were discharged at relative low and high constant currents of 3 mA and 43 mA, nominally corresponding to C/35 and C/2.5 discharge rates, respectively, for the cells containing the λ-MnO₂ of Examples 1a, 1b, and 1c. A C/35 discharge rate corresponds to the rate at which the total cell capacity is discharged in 35 hours. Similarly, a C/2.5 rate corresponds to the rate at which the total cell capacity is discharged in 2.5 hours. Gravimetric specific discharge capacities (i.e., mAh/g active material) for fresh cells discharged continuously to cutoff voltages of 1 V and 0.8 V are given in Table 3. Referring to FIG. 5, typical discharge curves for cells with cathodes including the λ-MnO₂ of Examples 1a, 1b, and 1c discharged at a relative low rate (i.e., C/35, ˜10 mA/g active) to a 0.8 V cutoff voltage, are shown. The discharge voltage profiles for typical cells containing the λ-MnO₂ of Examples 1b and 1c were nearly superimposable (i.e., tracked within about 15-20 mV) with that for a typical cell of Comparative Example 1 having a cathode including a commercial EMD (e.g., Tronox AB) down to a CCV of about 1 V. Cells including the λ-MnO₂ of Examples 1b and 1c provided up to 15-20% additional discharge capacity mainly on an elongated, flat plateau having a voltage ranging from about 1 V to 0.95 V. Further, cells of Examples 1b and 1c including λ-MnO₂ prepared by multiple acid extractions provided 7-10% additional capacity compared to cells including the λ-MnO₂ of Example 1a prepared by a single acid extraction. The values for the average discharge voltages of the cells of Examples 1a-c were nearly identical to that for a typical cell of Comparative Example 1. Cells with cathodes including either the λ-MnO₂ of Example 1b or the EMD of Comparative Example 1 also were discharged at a relative high rate (i.e., C/2.5, 100 mA/g active) to a 0.8 V cutoff voltage. The average discharge voltages for cells including the λ-MnO₂ of Example 1b and the EMD of Comparative Example 1 were about 1.1 V and 1.05 V, respectively. The high rate discharge capacities of both cells decreased by about 40-50% compared to the low rate capacities. Cells including the λ-MnO₂ of Example 1b provided about 10-15% greater capacity than cells including the EMD of Comparative Example 1. In addition, the high rate voltage profile for a cell including λ-MnO₂ also differed from that for a cell including EMD, in that after a steep initial voltage drop from OCV to about 1.1 V, there was a relatively flat plateau at about 1.07 V extending to about 50% DOD followed by a gradual decrease to the cutoff voltage.

### Example 2

### Synthesis of λ-MnO₂ from a Commercial Lithium Manganese Oxide Spinel

A λ-MnO₂ was synthesized by delithiation of a nominally stoichiometric lithium manganese oxide spinel obtained from Cams Corp. (Peru, Ill.) under the tradename CARUSel™ using the low temperature acid extraction process of Example 1 herein above. The spinel had a nominal chemical formula of Li_{1.01}Mn_{1.99}O₄ and was identical (i.e., same manufacturer lot number) to the commercial spinel used in the preparation of the λ-MnO₂ of Example 1 disclosed in commonly assigned U.S. Pat. No. 6,783,893. Values for measured physicochemical properties of the spinel are summarized in Table 1.

Approximately 100 g of dry spinel powder was added to about 1.5 L of rapidly stirred aqueous 6 M H₂SO₄ solution pre-cooled to between 0 and 5° C. The resulting slurry was maintained at about 2° C. and rapidly stirred for about 8 to 12 hours. After the stirring was stopped, the suspended solids were allowed to settle, the supernatant liquid removed by decantation, and a solid product collected by either pressure or vacuum filtration. The solid was washed with multiple aliquots of de-ionized water until pH of the washings was nearly neutral (i.e., pH ˜6-7). The solid was dried in air at about 60° C. for about 12-20 hours. The weight of the dried solid was about 69 g, corresponding to a weight loss of about 30% relative to the starting weight of spinel.

The X-ray powder diffraction pattern of the dried solid was consistent with the standard diffraction pattern reported for λ-MnO₂ (i.e., Powder Diffraction File No. 44-0992; International Centre for Diffraction Data, Newtown Square, Pa.). The multipoint N₂-adsorption B.E.T. specific surface area value of about 10.3 m²/g for the λ-MnO₂ powder was substantially larger than the 3.4 m²/g value for the spinel powder. The average particle size decreased from about 13.7 ™ for the spinel powder to 12.0 ™ for the λ-MnO₂ powder. Values for measured physicochemical properties of the λ-MnO₂ are summarized in Table 2A.

Button cells with cathodes containing the λ-MnO₂ of Example 2 were prepared in the same manner as the cells of Example 1. Typically, cells were tested within 24 hours after fabrication. OCV values were measured immediately before discharge and are given in Table 3. Referring to FIG. 5, the discharge curve for a typical cell with a cathode including the λ-MnO₂ of Example 2, discharged at a nominal C/35 rate (i.e., 10 mA/g active) to a 0.8 V cutoff voltage is shown. The discharge voltage profile for a typical cell of Example 2 was nearly superimposable with that for a typical cell of Comparative Example 1 (e.g., Tronox AB EMD) down to a CCV of about 1 V, and provided up to 12% greater capacity on an elongated, mostly on a flat plateau at about 1 V. The gravimetric specific capacity of a cell including the λ-MnO₂ of Example 2 was typically about 3-5% greater than that of a cell disclosed in Example 1 of U.S. Pat. No. 6,783,893. The additional discharge capacity for cells including the λ-MnO₂ of Example 2 can be attributed to the beneficial effect of low temperature acid extraction compared to acid extraction at about 15° C. as disclosed in Example 1 of U.S. Pat. No. 6,783,893.

### Comparative Example 1

### Commercial Electrolytic Manganese Dioxide

A commercial EMD powder was obtained, for example, from Tronox, Inc. (Oklahoma City, Okla.) under the tradename Tronox AB. Values for measured physicochemical properties of the EMD are summarized in Table 2A. The EMD was blended with natural graphite, for example, MP-0507 (i.e., NdG15) available from Nacionale de Grafite (Itapecerica, MG Brazil) and 38% KOH electrolyte solution containing 2 wt % zinc oxide in a weight ratio of 75:20:5. Button cells were prepared from the wet cathode mixture as described in Example 1 herein above. Typically, cells were tested within 24 hours after fabrication OCV values measured immediately before discharge, and are given in Table 3. Cells including the EMD of Comparative Example 1 were discharged to a cutoff voltage of 0.8 V at 3 mA (i.e., 10 mA/g) and 43 mA (i.e., 143 mA/g) constant currents, corresponding to nominal C/35 and C/2.5 discharge rates, respectively. Average gravimetric discharge capacity and OCV for cells including the EMD of Comparative Example 1 are given in Table 3. The low rate (i.e., 3 mA; 10 mA/g) discharge capacity of about 287 mAh/g is about 93% of the theoretical gravimetric specific capacity of 307 mAh/g for EMD. The high rate (i.e., 43 mA; 143 mA/g) discharge capacity was only about 60% that of the low rate specific capacity.

### Comparative Example 2 (C2)

### Synthesis of λ-MnO₂ from Commercial Lithium Manganese Oxide Spinel at 15° C.

A λ-MnO₂ was synthesized by delithiation of a nominally stoichiometric lithium manganese oxide spinel obtained from Carus Corp. (Peru, Ill.) under the tradename CARUSel™ by the acid extraction method disclosed in Example 1 of U.S. Pat. No. 6,783,893. Values for characteristic physicochemical properties of the spinel are summarized in Table 1. About 120 g of the spinel powder was added with stirring to about 200 ml of deionized water to form a slurry. The slurry was cooled to about 15° C. and a 6 M H₂SO₄ acid solution was added dropwise with constant stirring until pH of the slurry reached about 0.7 and remained at this value for at least 45 minutes. The acid addition rate was adjusted to maintain slurry temperature at about 15° C. The slurry was stirred for a total of 16 hours at pH 0.7. A solid was isolated from the slurry by either pressure or suction filtration and washed with multiple aliquots of de-ionized water until pH of the washings was nearly neutral (i.e., pH ˜6-7). The solid was dried in vacuo for 12 to 16 hours at 40° C. to 60° C. The weight of the dried solid was about 87 g, corresponding to a weight loss of about 27.5% relative to the starting weight of the spinel. The X-ray powder diffraction pattern of the dried solid was consistent with the standard diffraction pattern reported for λ-MnO₂ (i.e., Powder Diffraction File No. 44-0992; International Centre for Diffraction Data, Newtown Square, Pa.). The refined cubic unit cell constant decreased from a value of a₀=8.2420 Å for the spinel to a value of a₀=8.0350 Å for the λ-MnO₂. The B.E.T. specific surface area of the λ-MnO₂ powder of Comparative Example 2 was about 8.3 m²/g, substantially larger than the value of 3.4 m²/g for the precursor spinel powder. The average particle size of 13.4 ™ for the λ-MnO₂ powder was slightly less than the value of 13.7 ™ for the spinel powder. Values for measured physicochemical properties of the λ-MnO₂ are summarized in Table 2B.

Button cells with cathodes containing the λ-MnO₂ of Comparative Example 2 were prepared in the same manner as the cells of Example 1. Typically, cells were tested within 24 hours after fabrication and OCV values measured immediately before discharge. Cells were discharged at a nominal C/35 rate (i.e., 10 mA/g) to a 0.8 V cutoff voltage. Average gravimetric discharge capacity and OCV values for cells including the λ-MnO₂ of Comparative Example 2 are given in Table 3. The low rate capacity was about 97% of that of the cells of Example 2 prepared from the same precursor spinel.

TABLE 1
Physical and chemical properties of Li₁₊ₓMn₂₋ₓO₄ (−0.12 ≦ x < +0.12) spinel
powders

| | Examples/Comparative Examples | | | | | | | | |
|---|---|---|---|---|---|---|---|---|---|
| Properties | 1 | 2/C2 | 3a2 | 3b2 | 4a2 | C3a | C3b | C3c | C4b |
| Cell constant, aₒ(Å) | 8.2510 | 8.2420 | 8.2445 | 8.2441 | 8.2435 | 8.1962 | 8.2431 | 8.2310 | 8.2169 |
| BET SSA (m²/g) | 5.8 | 3.4 | 1.3 | 2.1 | 3.9 | 1.2 | — | 1.04 | — |
| Av. Part. Size (μm) | 4.1 | 13.7 | 1-2 | 1-2 | — | 4.0 | 3.8 | 9-13 | 0.5-3 |
| Ave pore size (Å) | 23 | 157 | 34 | 28 | 20 | — | — | 86 | — |
| TPV (cc/g) | 0.062 | 0.050 | 0.013 | 0.016 | 0.017 | — | — | 0.051 | — |
| Tap density (g/cm³) | 0.95-1 | 2.1 | 1.7-2 | 1.6 | 0.91 | 1.4 | 1.3 | 2.2 | 0.68 |
| True density (g/cm³) | 4.01 | 4.20 | 4.06 | 4.16 | 4.36 | 4.07 | 4.13 | 4.22 | — |
| Li/Mn (a/a) | 0.47 | 0.51 | — | 0.43 | 0.53 | 0.59 | 0.45 | 0.55 | — |
| Li₁₊ₓMn₂₋ₓO₄, x = ? | −0.04 | +0.01 | — | −0.10 | +0.03 | +0.11 | −0.07 | +0.06 | — |
| X-ray xtal size (nm) | 101 | — | 72 | 85 | 67 | 86 | 90 | — | 97 |

### Example 3

### Synthesis of λ-MnO₂ from a Lithium Manganese Oxide Spinel Prepared from a pCMD Precursor

A λ-MnO₂ was synthesized by delithiation of a nominally stoichiometric lithium manganese oxide spinel by the low temperature acid extraction process of Example 1 herein above. The spinel was prepared from a pCMD precursor synthesized by the general method disclosed in Example 5 of U.S. Pat. No. 5,277,890.

### Example 3a1

An aqueous 0.43 M Mn²⁺ solution was prepared by dissolving 131.18 g (0.78 mole) of hydrated manganous sulfate (MnSO₄.H₂O) in 1.8 L of de-ionized water at ambient room temperature. To the rapidly stirred Mn²⁺ solution, 185 g (0.78 mole) of solid sodium peroxydisulfate (Na₂S₂O₈) was added in portions. The stirred solution was heated from 20° C. to 50° C. in about 2 hours (i.e., ˜15° C./h) and then slowly heated from 50° C. to 65° C. during a period of about 8 hours (i.e., ˜2° C./h) and maintained at 65° C. for 18 hours. The solution slowly changed in color from clear, light pink to opaque brown and finally to a black suspension as pCMD formed. After 18 hours at 65° C., the slurry was heated from 65° C. to 80° C. during a period of about 8 hours (i.e., ˜2° C./h) and finally rapidly cooled to ambient room temperature in about 1 hour (i.e., ˜60° C./h). The suspended solids were allowed to settle and the supernatant liquid removed by decantation and discarded. The solids were recovered by pressure or vacuum filtration and washed with multiple aliquots of de-ionized water until the pH of the filtrate was nearly neutral (i.e., pH ˜6-7). The black solid product was dried in air at about 60° C.

The X-ray powder diffraction pattern of the dried solid was consistent with the standard pattern for crystalline γ-MnO₂ (or ramsdellite) (i.e., Powder Diffraction File No. 14-0644; International Centre for Diffraction Data, Newtown Square, Pa.) and is shown in FIG. 3. The dried pCMD powder of Example 3a1 had a tap density ranging from about 1.7 to 2.1 g/cm³. The overall particle morphology of the pCMD powder of Example 3a1 is depicted in the SEM image in FIG. 2a. The pCMD particles were composed of filamentous or needle-like crystallites (e.g., rods, laths) that are densely packed into agglomerates forming particles similar in aspect to the pCMD particles depicted in the SEM images depicted in FIGS. 1 and 2 of U.S. Pat. No. 5,277,890. Average particle size of the pCMD particles of Example 3a1 was about 4-10 μm (SEM).

### Example 3a2

A nominally stoichiometric lithium manganese oxide spinel was prepared by lithiation of the pCMD of Example 3a1 by treatment of the pCMD powder with a stoichiometric amount of LiOH dissolved in a salt melt containing a eutectic mixture of KCl and NaCl at a temperature of about 700-800° C. in air. For example, 20.00 g of the dried pCMD powder and 4.82 g of LiOH.H₂O (i.e., in a 2:1 Li:Mn atom ratio) were blended with 49.85 g of a eutectic mixture of KCl and NaCl salts blended in a 56:44 weight ratio. The resulting mixture was heated in air to form a melt (i.e., salt flux) and held at about 800° C. for about 12 hours. The heating was stopped and the mixture allowed to cool slowly to ambient room temperature. The resulting solid mass was broken up, washed with multiple portions of de-ionized water to dissolve the salts, and dried at about 60° C. in air. The dried solid was heated for about 6 hours at 700-800° C. in air and allowed to cool slowly to ambient room temperature.

The X-ray powder diffraction pattern of the dried solid corresponded closely to that reported for a stoichiometric lithium manganese oxide spinel (i.e., Powder Diffraction File No. 35-0782; International Centre for Diffraction Data, Newtown Square, Pa.). The refined cubic unit cell constant value of a₀=8.2445 Å was comparable to the values of 8.2510 Å and 8.2420 Å measured for the nominally stoichiometric commercial spinels of Examples 1 and 2, respectively. The value for the refined cubic unit cell constant was also consistent with values reported by Y. Gao and J. R. Dahn (Journal of the Electrochemical Society, 1996, 143(1), 100-114) for spinels with a nominal chemical formula of Li₁₊ₓMn₂₋ₓO₄, where 0.00×0.04, having values for cell constants ranging from 8.2429 to 8.2486 Å. The X-ray crystallite size of the spinel of Example 3a2 calculated by the Scherrer method was about 72 nm compared to a value of about 101 nm for the spinel of Example 1. The spinel of Example 3a2 had a tap density of about 1.7-2.0 g/cm³, an average particle size of about 1-2 μm (SEM), and a relatively low B.E.T. specific surface area of only about 1.3 m²/g. Values for measured physicochemical properties of the spinel are summarized in Table 1.

### Example 3a3

A λ-MnO₂ was prepared via delithiation of the spinel of Example 3a2 using the acid extraction process of Example 1. The X-ray powder diffraction pattern of the dried product was nearly identical to that reported for λ-MnO₂ (i.e., Powder Diffraction File No. 44-0992; International Centre for Diffraction Data, Newtown Square, Pa.). The refined cubic unit cell constant value of a₀=8.0365 Å is consistent with the value of 8.0437 Å for the λ-MnO₂ of Example 1b. The X-ray crystallite size of the λ-MnO₂ of Example 3a3 calculated by the Scherrer method was about 47 nm, somewhat smaller than the values for the λ-MnO₂ of Examples 1a-c. Based on the value of the refined cubic cell constant, the chemical formula was estimated as Li_{0.016}MnO₂. The B.E.T. specific surface area value of about 9 m²/g for the λ-MnO₂ powder is substantially larger than that of the spinel of Example 3a2. The average particle size of the λ-MnO₂ primary particles was about 0.5-2.0 μm (SEM). The λ-MnO₂ powder had a true density (i.e., He pycnometer density) of about 4.53 g/cm³ and a tap density of about 1.7 g/cm³. Values for measured physicochemical properties of the λ-MnO₂ are summarized in Table 2A.

### Example 3b1

An aqueous 0.4 M Mn²⁺ solution was prepared by dissolving 120 g (0.71 mole) of hydrated manganous sulfate (MnSO₄.H₂O) in 1.8 L of de-ionized water at ambient room temperature. To the rapidly stirred Mn²⁺ solution, 161.7 g (0.71 mole) of solid ammonium peroxydisulfate ((NH₄)₂S₂O₈) was added. The stirred solution was heated from 20° C. to 50° C. in about 2 hours (i.e., ˜15° C./h) and held at 50° C. The solution slowly changed in color from clear, light pink to opaque brown and finally, a black suspension of pCMD formed. After 18 hours at 50° C., the slurry was heated from 50° C. to 75° C. during a period of about 1 hour (i.e., ˜25° C./h) and held at 75° C. for 3 hours. The slurry was then heated to 100° C. during a period of about 2 hours (i.e., ˜12° C./h), held for 2 hours at 100° C., and rapidly cooled to ambient room temperature in about 1 hour (i.e., ˜60° C./h). The suspended solids were allowed to settle and the supernatant liquid removed by decantation. The solids were recovered by pressure or vacuum filtration and washed with multiple protons of de-ionized water until the filtrate was nearly neutral (i.e., pH ˜6-7). The black solid was dried in air at about 60° C. The X-ray powder diffraction pattern of the dried solid was consistent with the standard pattern for α-MnO₂ (i.e., Powder Diffraction File No. 44-0141; International Centre for Diffraction Data, Newtown Square, Pa.) with several minor peaks that could be attributed to the presence of γ-MnO₂ as a minor impurity and is shown in FIG. 3. The values for the refined tetragonal unit cell constants were determined to be a₀=9.7847 Å and c₀=2.8630 Å. The dried pCMD powder had a tap density ranging from about 1.1 to 1.3 g/cm³. The overall particle morphology of the pCMD powder of Example 3b1 is depicted in the SEM image in FIG. 2b. Compared to the morphology of the particles of the pCMD powder of Example 3a1 in FIG. 2a, the average diameter of the filamentous or needle-like crystallites was smaller (e.g., nanometric), the average length was longer, and the crystallites were packed less densely into agglomerates. Average particle size of the pCMD agglomerates was about 7-10 μm (SEM).

### Example 3b2

A nominally stoichiometric lithium manganese oxide spinel was prepared by lithiation of the pCMD of Example 3b1 in a eutectic 56:44 (w/w) KCl:NaCl salt melt by the method of Example 3a2 herein above. The X-ray powder diffraction pattern of the dried solid product corresponded closely to the standard pattern for a stoichiometric lithium manganese oxide spinel (i.e., Powder Diffraction File No. 35-0782; International Centre for Diffraction Data, Newtown Square, Pa.) and is shown in FIG. 3. The refined cubic unit cell constant, a₀=8.2441 Å was comparable to that of the spinel of Example 3a2. The X-ray crystallite size of the spinel of Example 3b2 calculated by the Scherrer method was about 85 nm, somewhat smaller than the value for the spinel of Example 1. The lithium content of the spinel was determined by AA spectroscopy to be 3.50 wt % and the manganese content determined by ICP-AE spectroscopy to be 63.7 wt %, corresponding to a Li/Mn atom ratio of 0.435 and a calculated chemical formula of Li_{0.90}Mn_{2.10}O₄. The B.E.T. specific surface area was about 2.1 m²/g. An SEM image of a large (e.g., 10-15 μm) agglomerate of small isotropic (i.e., block-shaped) spinel particles of Example 3b2 is shown in FIG. 4a. The average particle size of the spinel primary particles was about 1-2 μm (SEM). The spinel powder had a true density of about 4.16 g/cm³ and a tap density of about 1.6 g/cm³. Values for measured physicochemical properties of the spinel are summarized in Table 1.

### Example 3b3

A λ-MnO₂ was prepared by delithiation of the spinel of Example 3b2 using the acid extraction process of Example 1. The X-ray powder diffraction pattern of the dried solid corresponded closely to the standard pattern for λ-MnO₂ (i.e., Powder Diffraction File No. 44-0992; International Centre for Diffraction Data, Newtown Square, Pa.). The refined cubic unit cell constant, a₀=8.0300 Å was comparable to that of the λ-MnO₂ of Example 3a3. The X-ray crystallite size of the λ-MnO₂ of Example 3b3 was calculated by the Scherrer method as about 50 nm, nearly identical to that of the λ-MnO₂ of Example 3a3. The B.E.T. specific surface area of about 10.0 m²/g was also nearly the same as that for the λ-MnO₂ of Example 3a3. The λ-MnO₂ had a true density of about 4.26 g/cm³ and a tap density of about 1.3-1.6 g/cm³. An SEM image of a large (e.g., 10-15 μm) agglomerate of small irregular shaped λ-MnO₂ particles of Example 3b3 is depicted in FIG. 4b. The average particle size of the λ-MnO₂ primary particles was about 0.25-1.0 ™ (SEM). The residual lithium content of the λ-MnO₂ of Example 3b3 was determined by AA spectroscopy to be 0.107 wt % and the manganese content determined by ICP-AE spectroscopy to be 63.3 wt %, corresponding to a Li/Mn atom ratio of 0.435 and a calculated chemical formula of about Li_{0.013}MnO₂. Values for measured physicochemical properties of the λ-MnO₂ of Example 3b3 are summarized in Table 2A.

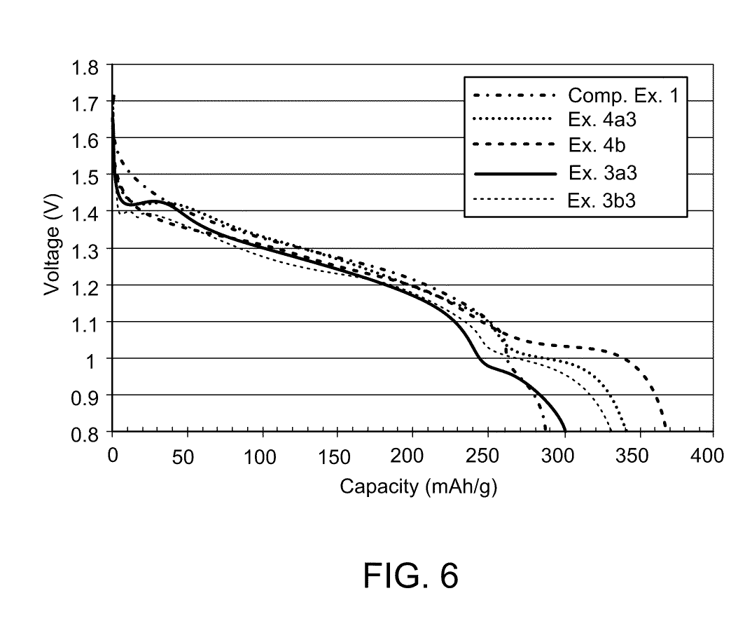

Button cells with cathodes containing the λ-MnO₂ of Examples 3a3 and 3b3 were prepared in the same manner as the cells of Example 1. Typically, cells were tested within 24 hours after fabrication and the OCV values measured immediately before discharge. Average gravimetric discharge capacities and OCV values for cells including the λ-MnO₂ of Examples 3a3 and 3b3 are given in Table 3. Referring to FIG. 6, the discharge curves for typical cells with cathodes including the λ-MnO₂ of Examples 3a3 and 3b3, discharged at a nominal C/35 rate (i.e., 10 mA/g active) to a 0.8 V cutoff voltage are shown. The discharge voltage profile for a typical cell of Example 3a3, after an initial voltage dip of about 150 mV, was nearly superimposable on that for a typical cell of Comparative Example 1 down to a CCV of about 1 V, and provided about 8% greater capacity to a 0.8 V cutoff voltage. The discharge voltage profile for a typical cell of Example 3b3, after an initial voltage dip of about 200 mV, tracked about 20-40 mV lower than a typical cell of Comparative Example 1 down to a CCV of about 1 V, and provided nearly 20% greater capacity at low discharge rate to a 0.8 V cutoff voltage.

The additional capacity for cells including the λ-MnO₂ of Examples 3a3 and 3b3 can be attributed to the combination of using a p-CMD-type precursor to prepare a nominally stoichiometric precursor spinel having a relatively high specific surface area as well as the use of the low temperature acid extraction process to prepare the λ-MnO₂. It is believed that the somewhat larger capacity of cells including the λ-MnO₂ of Example 3b3 compared to cells including the λ-MnO₂ of Example 3a3 resulted from the higher surface area of the corresponding precursor spinel and the lower residual lithium content of the λ-MnO₂ as reflected in the smaller refined cubic unit cell constant for the λ-MnO₂ of Example 3b3.

### Example 4

### Synthesis of λ-MnO₂ from a Lithium Manganese Oxide Spinel Prepared from a hydrothermally synthesized precursor CMD

A λ-MnO₂ was synthesized by delithiation of a nominally stoichiometric lithium manganese oxide spinel by the low temperature acid extraction process of Example 1 herein above. The spinel was prepared from a precursor CMD synthesized by the chemical oxidation of Mn²⁺ ions in an aqueous solution at an elevated temperature in a sealed pressure vessel by a hydrothermal treatment. The hydrothermal treatment was similar to that described by F. Cheng et al. (Inorganic Chemistry, 2005, 45(5), 2038-2044) for the preparation of nanostructured γ-MnO₂ particles.

### Example 4a1

An aqueous 0.2 M Mn²⁺ solution was prepared by dissolving 40 g (0.24 mole) of hydrated manganous sulfate (MnSO₄.H₂O) in 1.2 L of de-ionized water at ambient room temperature. The Mn²⁺ solution was transferred to a 2 liter capacity hydrothermal pressure vessel fabricated from Hastelloy C-276 alloy (e.g., Model 4520, Parr Instrument Co., Moline, Ill.) with a Teflon liner. To the Mn²⁺ solution, 54.0 g (0.24 mole) of solid ammonium peroxydisulfate ((NH₄)₂S₂O₈) was added. The pressure vessel was hermetically sealed and purged with an inert gas (e.g., argon, nitrogen) for about 5-10 minutes. The mixture was heated with stirring (300 rpm) from ambient room temperature to 80° C. in about 0.5 hour and held at 80° C. for 3 hours. Heating was stopped and the pressure vessel and contents allowed to cool to ambient room temperature before removal of the product. A solid product was isolated by pressure or vacuum filtration of the mixture and washed with multiple portions of de-ionized water until the pH of the filtrate was nearly neutral (i.e., pH ˜6-7). The black solid product was dried at about 60° C. in air for about 12-16 hours.

The X-ray powder diffraction pattern of the dried solid was consistent with the standard pattern for crystalline γ-MnO₂ (or ramsdellite) (i.e., Powder Diffraction File No. 14-0644; International Centre for Diffraction Data, Newtown Square, Pa.) and is depicted in FIG. 3. The dried CMD powder of Example 4a1 had a tap density ranging from about 0.4 to 1.0 g/cm³. The overall particle morphology of the CMD powder of Example 4a1 is depicted in the SEM image in FIG. 2c. The CMD particles were composed of filamentous or needle-like crystallites having nanometric dimensions densely packed into agglomerates forming sea urchin-shaped particles similar to the γ-MnO₂ particles described by F. Cheng et al. (Inorganic Chemistry, 2005, 45(5), 2038-2044). The average particle size of the CMD particle agglomerates of Example 4a1 ranged from about 2-10 μm (SEM).

### Example 4a2

A nominally stoichiometric lithium manganese oxide spinel was prepared by lithiation of the CMD of Example 4a1 in a eutectic 56:44 (w/w) KCl:NaCl salt melt by the method of Example 3a2 herein above. The X-ray powder diffraction pattern of the dried solid corresponded closely to that reported for a stoichiometric lithium manganese oxide spinel (i.e., Powder Diffraction File No. 35-0782; International Centre for Diffraction Data, Newtown Square, Pa.). The value of the refined cubic unit cell constant, a₀=8.2435 Å corresponds closely to that of the spinel of Example 3a2. The X-ray crystallite size of the spinel of Example 4a2 was calculated by the Scherrer method as 67 nm and is similar to that of the spinel of Example 3a2. The lithium content of the spinel of Example 4a2 was determined by AA spectroscopy to be 4.01 wt % and the manganese content determined by ICP-AE spectroscopy to be 60.24 wt %, corresponding to a Li/Mn atom ratio of 0.527 and a calculated chemical formula of Li_{1.03}Mn_{1.97}O₄. The B.E.T. specific surface area of the spinel powder was about 3.9 m²/g and the average particle size was about 1-2 μm (SEM). The spinel powder had a true density of about 4.36 g/cm³ and a tap density of about 0.9 g/cm³. Values for measured physicochemical properties of the spinel of Example 4a2 are summarized in Table 1.

### Example 4a3

A λ-MnO₂ was synthesized by delithiation of the spinel of Example 4a2 using the low temperature acid extraction process of Example 1. The X-ray powder diffraction pattern of the dried solid product was consistent with the standard pattern reported for λ-MnO₂ (i.e., Powder Diffraction File No. 44-0992; International Centre for Diffraction Data, Newtown Square, Pa.). The value of the refined cubic unit cell constant, a₀=8.0324 Å was comparable to that of the λ-MnO₂ of Example 3a3. The X-ray crystallite size of the λ-MnO₂ was calculated by the Scherrer method as about 51 nm. The B.E.T. specific surface area of about 6.6 m²/g was somewhat less than the values for the λ-MnO₂ of Examples 3a3 and 3b3. The λ-MnO₂ powder had a true density of about 4.15 g/cm³ and a tap density of about 1.0-1.5 g/cm³. The average particle size of the λ-MnO₂ primary particles ranges from about 0.75-1.0 ™ (SEM). The residual lithium content of the λ-MnO₂ of Example 4a3 was determined by AA spectroscopy to be 0.11 wt % and the manganese content determined by ICP-AE spectroscopy to be 60.2 wt %, corresponding to a calculated chemical formula of Li_{0.015}MnO₂. Values for measured physicochemical properties of the λ-MnO₂ of Example 4a3 are summarized in Table 2A.

Button cells with cathodes including the λ-MnO₂ of Example 4a3 were prepared in the same manner as the cells of Example 1. Typically, cells were tested within 24 hours after fabrication and OCV values measured immediately before discharge. Average gravimetric discharge capacities to 0.8 V and 1 V cutoff voltages and OCV values for cells including the λ-MnO₂ of Example 4a3 are given in Table 3. Referring to FIG. 6, a discharge curve for a typical cell including the λ-MnO₂ of Example 4a3, discharged at a nominal C/35 rate (i.e., 10 mA/g active) to a 0.8 V cutoff voltage is shown. Relative to the discharge voltage profile shown for a typical cell of Comparative Example 1, the voltage profile for a typical cell of Example 4a3, after an initial voltage dip of about 150 mV, tracked about 20-40 mV lower to a CCV value of about 1 V. At low discharge rate, cells of Example 4a3 provided nearly 20% greater gravimetric capacity to a 0.8 V cutoff voltage than cells of Comparative Example 1. Also, cells of Example 4a3 provided gravimetric capacity comparable to the cells of Example 1b including a λ-MnO₂ prepared from a commercial spinel as well as that of cells of Example 3b3 including a λ-MnO₂ prepared from a spinel synthesized from a pCMD.

### Example 4b

A 10 g sample of the λ-MnO₂ of Example 4a3 was blended with an oxidation-resistant graphite, for example Timrex® SFG-15 (Timcal Ltd., Bodio, Switzerland) in a weight ratio of λ-MnO₂ to graphite of 5 to 1 and then subjected to a high-energy milling treatment by, for example, a SPEX Model 8000D CertiPrep® Dual Mixer/Mill with zirconia mixing chambers and media.

Button cells of Example 4b with cathodes including the high-energy milled mixture of the λ-MnO₂ of Example 4a3 and the oxidation-resistant graphite were prepared in the same general manner as the cells of Example 1. Typically, cells were tested within 24 hours after fabrication and OCV values measured immediately before discharge. Average gravimetric discharge capacities to 0.8 V and 1 V cutoff voltages and OCV values for cells including the λ-MnO₂ of Example 4b are given in Table 3. The average OCV value of 1.65 V is comparable to that of cells of Comparative Example 1 including commercial EMD and is lower than typical values of 1.67-1.70 V for other cells including λ-MnO₂, for example, cells of Example 2. Referring to FIG. 6, a discharge curve for a typical cell of Example 4b discharged at a nominal C/35 rate (i.e., 10 mA/g active) to a 0.8 V cutoff voltage is shown. Relative to the discharge voltage profile for a typical cell of Comparative Example 1, the voltage profile for a typical cell of Example 4b, after an initial voltage dip of about 100 mV in the first 10-15% of discharge, tracked about 10-30 mV lower until a CCV value of about 1.1 V. Referring to Table 3, at low discharge rates, the cells of Example 4b provided nearly 30% more discharge capacity than cells of Comparative Example 1, mainly on an elongated, flat plateau at about 1.05 to 1.0 V. The average capacity of the cells of Example 4b corresponded to greater than 90% of the theoretical gravimetric specific capacity (i.e., about 410 mAh/g) for λ-MnO₂ based on a 1.33 electron reduction. Cells of Example 4b also provided 8-10% more capacity than cells including the λ-MnO₂ of Example 4a3 at the low discharge rate. Further, cells of Example 4b discharged at a nominal C/2.5 high rate (e.g., 100 mA/g λ-MnO₂) provided nearly 50% more capacity than the cells of Comparative Example 1 discharged at the same rate to a 0.8 V cutoff voltage.

Without wishing to be bound by theory, it is believed that the substantial improvement in low rate as well as high rate performance of the cells of Example 4b can be attributed to lower cathode impedance resulting from the decrease in inter-particle resistivity arising from a more intimate contact between graphite particles and λ-MnO₂ particles resulting from the high energy milling treatment.

TABLE 2A
Physical and chemical properties of λ-MnO₂ powders

| | Examples | | | | | | |
|---|---|---|---|---|---|---|---|
| Properties | 1a | 1b | 1c | 2 | 3a3 | 3b3 | 4a3 |
| Cell constant, aₒ (Å) | 8.0493 | 8.0437 | 8.0439 | — | 8.0365 | 8.0300 | 8.0324 |
| BET SSA (m²/g) | 15.8 | 24.1 | 19.0 | 10.3 | 9.0 | 10.0 | 6.6 |
| Ave. Part. Size (μm) | 3.0 | 2.9 | 2.9 | 12.0 | 0.5-2 | 0.25-1 | 0.75-1 |
| Ave pore size (Å) | 23 | 36 | 20 | | | 28 | — |
| TPV (cc/g) | 0.100 | 0.095 | 0.082 | — | — | 0.058 | — |
| Tap density (g/cm³) | 1.1 | 1.1 | 1.14 | — | 1.7 | 1.3-1.6 | 1-1.5 |
| True density (g/cm³) | 4.18 | 4.21 | 4.47 | — | 4.53 | 4.26 | 4.15 |
| Li/Mn (a/a) | 0.041 | 0.025 | 0.017 | — | — | 0.013 | 0.015 |
| X-ray xtal size (nm) | 72 | 74 | 72 | — | 47 | 50 | 51 |

TABLE 2B
Physical and chemical properties of λ-MnO₂ powders

| Prop- | Comparative Examples | | | | | |
|---|---|---|---|---|---|---|
| erties | C1 | C2 | C3a | C3b | C3c | C4c |
| Cell | — | 8.0350 | 8.0483 | 8.0391 | 8.0476 | 8.0603 |
| con- | | | | | | |
| stant, | | | | | | |
| aₒ (Å) | | | | | | |
| BET | 48.0 | 8.3 | — | 6.6 | 5.0 | 7.2 |
| SSA | | | | | | |
| (m²/g) | | | | | | |
| Ave. | 47.5 | 13.4 | — | 2-10 | — | 0.5-3 |
| Part. | | | | | | |
| Size | | | | | | |
| (μm) | | | | | | |
| Ave | 36 | 37 | — | 25 | — | 18 |
| pore | | | | | | |
| size | | | | | | |
| (Å) | | | | | | |
| TPV | 0.072 | 0.11 | — | 0.067 | — | 0.043 |
| (cc/g) | | | | | | |
| Tap | 2.45 | — | — | 1.7 | — | 0.8 |
| den- | | | | | | |
| sity | | | | | | |
| (g/ | | | | | | |
| cm³) | | | | | | |
| True | 4.50 | 4.44 | — | 4.39 | 4.34 | — |
| den- | | | | | | |
| sity | | | | | | |
| (g/ | | | | | | |
| cm³) | | | | | | |
| Li/Mn | — | — | — | 0.059 | 0.033 | — |
| (a/a) | | | | | | |
| X-ray | — | — | 76 | 48 | 72 | 73 |
| xtal | | | | | | |
| size | | | | | | |
| (nm) | | | | | | |

### Comparative Example 3

### Synthesis of λ-MnO₂ from a Commercial Lithium Manganese Oxide Spinel

### Comparative Example 3a

A λ-MnO₂ was synthesized by delithiation of a commercial lithium manganese oxide spinel having an excess lithium stoichiometry available from Toda Kogyo Corp. (Yamaguchi, Japan) under the trade designation HPM-6010 by the low temperature acid extraction process of Example 1 herein above. The spinel has a nominal chemical composition of Li_{1.11}Mn_{1.89}O₄ and a refined cubic unit cell constant of 8.1930 Å. Spinel powder properties include a B.E.T. specific surface area of 1.2 m²/g and an average particle size of 4.0 μm. The spinel had a true density of 4.07 g/cm³ and a tap density of 1.4 g/cm³. Values for measured physicochemical properties of the spinel are summarized in Table 1.

Approximately 100 g of dry spinel powder was added to about 1.5 L of rapidly stirred aqueous 6 M H₂SO₄ solution that had been cooled to between 0 and 5° C. The resulting slurry was maintained at about 2° C. and rapidly stirred for about 8 to 12 hours. After the stirring was stopped, the suspended solids were allowed to settle, the supernatant liquid removed by decantation, and a solid product collected by either pressure or vacuum filtration. The solid was washed with multiple aliquots of de-ionized water until pH of the washings was nearly neutral (i.e., pH ˜6-7). The solid was dried in air at about 60° C. for about 12-20 hours. The weight of the dried solid was about 69 g, which corresponds to a weight loss of about 30% relative to the initial weight of the precursor spinel.

The X-ray powder diffraction pattern of the dried product was consistent with the standard diffraction pattern reported for λ-MnO₂ (i.e., Powder Diffraction File No. 44-0992; International Centre for Diffraction Data, Newtown Square, Pa.). The value of the refined cubic unit cell constant of the λ-MnO₂ of Comparative Example 3a was a₀=8.0483 Å and the X-ray crystallite size calculated by the Scherrer method was about 76 nm. Based on the value of the refined cubic cell constant, the chemical formula was estimated to be about Li_{0.04}MnO₂.

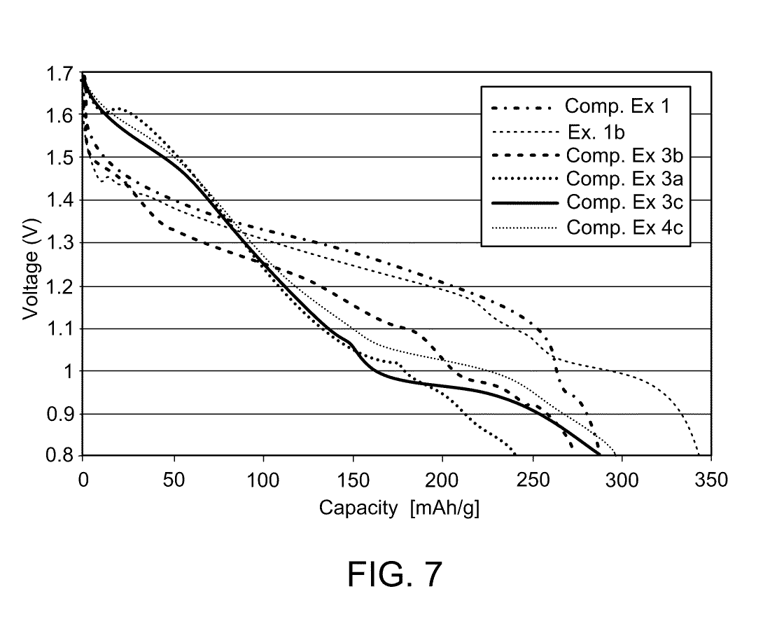

Button cells with cathodes including the λ-MnO₂ of Comparative Example 3a were prepared in the same manner as the cells of Example 1. Typically, the cells were tested within 24 hours after fabrication and OCV values measured immediately before discharge. Average gravimetric discharge capacities to 0.8 V and 1 V cutoff voltages and OCV for cells including the λ-MnO₂ of Comparative Example 3a are given in Table 3. Referring to FIG. 7, the discharge curve for a typical cell including the λ-MnO₂ of Comparative Example 3a, discharged at a nominal C/35 rate (i.e., 10 mA/g active) to a 0.8 V cutoff voltage is shown. Relative to the discharge voltage profile shown for a typical cell of Comparative Example 1, the voltage profile for a typical cell of Comparative Example 3a has a strongly sloping curve starting from an initial OCV value of 1.77 V which is much higher than that of the cells of Comparative Example 1. In addition, the CCV is higher for the first 20-30% of discharge. However, the cells of Comparative Example 3a provided about 16% less gravimetric capacity to a 0.8 V cutoff voltage than the cells of Comparative Example 1 and also had a 7% lower average discharge voltage for the same discharge rate.

It is believed that the lower discharge capacity for the cells of Comparative Example 3a can be attributed to the presence of excess lithium in the precursor spinel as well as the corresponding lower Mn³⁺ content than in the case of a nominally stoichiometric spinel. This lower Mn³⁺ content can result in an increase in exchange of Li⁺ ions by protons during the acid extraction process to form λ-MnO₂. It is further believed that the presence of protons occupying the 8a lattice sites previously occupied by the Li⁺ ions can impact the solid state diffusion of protons inserted during discharge, and combined with fewer total Mn⁴⁺ ions, can produce the observed decrease in the discharge capacity.

### Comparative Example 3b

A λ-MnO₂ was synthesized by delithiation of a commercial lithium manganese oxide spinel with an excess lithium stoichiometry available from Sigma-Aldrich Co. (Milwaukee, Wis.) as product number 482277 by the low temperature acid extraction process of Example 1 herein above. The spinel has a nominal chemical composition of Li_{0.93}Mn_{2.07}O₄. The spinel had a refined cubic unit cell constant of 8.2310 Å and an X-ray crystallite size calculated by the Scherrer method of about 90 nm. Spinel powder properties include a B.E.T. specific surface area of 1.04 m²/g and an average particle size of 3.8 μm. The spinel had a true density of 4.13 g/cm³ and a tap density of 1.3 g/cm³. Values for measured physicochemical properties of the spinel are summarized in Table 1.

The λ-MnO₂ of Comparative Example 3b was prepared in the same manner as the λ-MnO₂ of Comparative Example 3a. The X-ray powder diffraction pattern of the dried product also was consistent with the standard diffraction pattern reported for λ-MnO₂ (i.e., Powder Diffraction File No. 44-0992; International Centre for Diffraction Data, Newtown Square, Pa.). The value of the refined cubic unit cell constant of the λ-MnO₂ of Comparative Example 3b was a₀=8.0391 Å and the X-ray crystallite size of calculated by the Scherrer method was about 48 nm. The multipoint N₂-adsorption B.E.T. surface area value for the λ-MnO₂ powder was about 6.6 m²/g and the average particle size was about 2-10 microns. The residual lithium content of the λ-MnO₂ of Comparative Example 3b was determined by AA spectroscopy to be 0.483 wt % and the manganese content determined by ICP-AE spectroscopy was 64.9 wt %, corresponding to a calculated chemical formula of Li_{0.059}MnO₂. Values for measured physicochemical properties of the λ-MnO₂ of Comparative Example 3b are summarized in Table 2B.

Button cells with cathodes including the λ-MnO₂ of Comparative Example 3b were prepared in the same manner as the cells of Example 1. Typically, cells were tested within 24 hours after fabrication and OCV values measured immediately before discharge. Average gravimetric discharge capacities to 0.8 V and 1 V cutoff voltages and OCV for cells including the λ-MnO₂ of Comparative Example 3b are given in Table 3. Referring to FIG. 7, the discharge curve for a typical cell including the λ-MnO₂ of Comparative Example 3b, discharged at a nominal C/35 rate (i.e., 10 mA/g active) to a 0.8 V cutoff voltage is shown. Relative to the discharge voltage profile for a typical cell of Comparative Example 1, the voltage profile for a typical cell of Comparative Example 3b has a somewhat higher initial OCV value of 1.71 V, tracked 10-20 mV below that of the cells of Comparative Example 1 for the first 10-15% of discharge, and then decreased more rapidly to the cutoff voltage. Thus, the cells of Comparative Example 3b provided about 5% less gravimetric capacity than the cells of Comparative Example 1 and about 5% lower average discharge voltage.

### Comparative Example 3c

A λ-MnO₂ can be synthesized by delithiation of a commercial lithium manganese oxide spinel with an excess lithium stoichiometry available from Tronox (Oklahoma City, Okla.) under the trade designation Grade 210 CMO by the low temperature acid extraction process of Example 1 herein above. The spinel has a nominal chemical composition of Li_{1.06}Mn_{1.94}O₄ and a refined cubic unit cell constant of 8.2310 Å. Spinel powder properties include a B.E.T. specific surface area of 1.04 m²/g, an average particle size of 9-13 μm, a true density of 4.22 g/cm³, and a tap density of 2.2 g/cm³. Values for measured physicochemical properties of the spinel are summarized in Table 1.

The λ-MnO₂ of Comparative Example 3c was prepared in the same manner as the λ-MnO₂ of Comparative Example 3a. The X-ray powder diffraction pattern of the dried product also was consistent with the standard diffraction pattern reported for λ-MnO₂ (i.e., Powder Diffraction File No. 44-0992; International Centre for Diffraction Data, Newtown Square, Pa.). The value of the refined cubic unit cell constant of the λ-MnO₂ of Comparative Example 3c was a₀=8.0476 Å and the X-ray crystallite size of calculated by the Scherrer method was about 72.5 nm. The B.E.T. surface area for the λ-MnO₂ powder was 5.0 m²/g. Based on the value of the refined cubic cell constant, the chemical formula was estimated to be about Li_{0.033}MnO₂.

Button cells with cathodes including the λ-MnO₂ of Comparative Example 3c were prepared in the same manner as the cells of Example 1. Cells were tested within 24 hours after fabrication and OCV values measured immediately before discharge. Average gravimetric discharge capacities to 0.8 V and 1 V cutoff voltages and OCV values for cells including the λ-MnO₂ of Comparative Example 3c are given in Table 3. Referring to FIG. 7, the discharge curve for a typical cell including the λ-MnO₂ of Comparative Example 3c, discharged at a nominal C/35 rate (i.e., 10 mA/g active) to a 0.8 V cutoff voltage is shown. Relative to the voltage profile for a typical cell of Comparative Example 1, the voltage profile for a typical cell of Comparative Example 3c has a higher initial OCV of 1.76 V, tracked 50-75 mV above that of the cells of Comparative Example 1 for the first 30% of discharge, and thereafter decreased more rapidly to the cutoff voltage. The cells of Comparative Example 3c had nearly the same gravimetric specific capacity to a 0.8 V cutoff voltage as the cells of Comparative Example 1, but about 10% lower average discharge voltage.

### Comparative Example 4

### Synthesis of λ-MnO₂ from Lithium Manganese Oxide Spinel Prepared from a Precursor Cmd Prepared by Thermal Decomposition of KMnO₄

A λ-MnO₂ was synthesized by delithiation of a nominally stoichiometric lithium manganese oxide spinel by the low temperature acid extraction process of Example 1 herein above. The spinel was synthesized from a precursor CMD having a potassium birnessite (δ-KₓMnO₂) structure by a hydrothermal lithiation reaction followed by heat treatment at an elevated temperature as described by Y. Lu et al. (Electrochimica Acta, 2004, 49, 2361-2367). The CMD was prepared by thermal decomposition of solid potassium permanganate (KMnO₄) powder at an elevated temperature in air as described by S. Komaba et al. (Electrochimica Acta, 2000, 46, 31-5).

### Comparative Example 4a

Approximately 60 g solid potassium permanganate was placed in an alumina crucible and heated in air to 600° C. for 5 hours to form a product powder consisting of a mixture of manganese oxide phases including water-soluble potassium manganates, for example, K₂MnO₄ and K₃MnO₄ as well as an insoluble layered 6-MnO₂ phase. The powder was added to 1 to 1.5 liters of de-ionized water at ambient room temperature and stirred for 0.25-0.5 hour to extract soluble reaction products. Stirring was stopped, the solids allowed to settle, and the supernatant liquid decanted and discarded. Water extraction of the solid was repeated until the supernatant liquid was clear and colorless. The solid was isolated by filtration (e.g., suction filtration, vacuum filtration) or centrifugation. The solid product was dried at 80° C. in air for about 12-24 hours. The X-ray powder diffraction pattern of the dried product was consistent with the diffraction pattern reported by Y. Lu et al. (Electrochimica Acta, 2004, 49, 2361-2367) for 6-KₓMnO₂ having a layered potassium-containing birnessite-type structure with a characteristic interlayer spacing of d₀₀₁=7.10-7.15 Å.

### Comparative Example 4b

Approximately 10 g of the dried 6-KₓMnO₂ of Comparative Example 4a was added to 0.4 liter of 5 M LiOH aqueous solution and heated with stirring at 75-85° C. for 6 to 8 hours. Heating was stopped, the solids allowed to settle, and the supernatant liquid decanted and discarded. A 1 to 1.5 liter portion of deionized water at ambient room temperature was added to the solids and the mixture stirred for 0.25-0.5 hour. The solids were allowed to settle and the supernatant liquid decanted. The entire washing process was repeated 3 to 4 times to dissolve unreacted Li salts (e.g., LiOH, Li₂CO₃). The solid product was isolated by filtration or centrifugation as above and dried in air at 80° C. The dried powder was heat-treated in air at 750-800° C. for 5 hours. The X-ray powder diffraction pattern of the heat-treated product corresponded closely to that reported for a stoichiometric lithium manganese oxide spinel (i.e., Powder Diffraction File No. 35-0782; International Centre for Diffraction Data, Newtown Square, Pa.). The value of the refined cubic unit cell constant of the spinel of Comparative Example 4b was a₀=8.2169 Å and the X-ray crystallite size calculated by the Scherrer method was about 97.5 nm. The average particle size of the spinel ranged from 0.5-3.0 ™ (SEM). The spinel had a tap density of only 0.68 g/cm³.

### Comparative Example 4c

The λ-MnO₂ was prepared via delithiation of the spinel powder of Comparative Example 4b using the low temperature acid extraction process of Example 1. The X-ray powder diffraction pattern of the dried solid product was consistent with that reported for λ-MnO₂ (i.e., Powder Diffraction File No. 44-0992; International Centre for Diffraction Data, Newtown Square, Pa.). The value for the refined cubic unit cell constant of the λ-MnO₂ was a₀=8.0603 Å and the X-ray crystallite size calculated by the Scherrer method was about 73 nm. The B.E.T. specific surface area was about 7.2 m²/g and the average particle size was about 0.5-3 μm (SEM). The λ-MnO₂ of Comparative Example 4c had a tap density of only about 0.8 g/cm³. Values for measured physicochemical properties of the λ-MnO₂ of Comparative Example 4c are summarized in Table 2B.

Button cells with cathodes including the λ-MnO₂ of Comparative Example 4c were prepared in the same manner as the cells of Example 1. Typically, cells were tested within 24 hours after fabrication and OCV values measured immediately before discharge. Average gravimetric discharge capacities to 0.8 V and 1 V cutoff voltages and OCV values for cells including the λ-MnO₂ of Comparative Example 4c are given in Table 3. Referring to FIG. 7, the discharge curve for a typical cell including the λ-MnO₂ of Comparative Example 4c, discharged at a nominal C/35 rate (i.e., 10 mA/g active) to a 0.8 V cutoff voltage is shown. Relative to the discharge voltage profile shown for a typical cell of Comparative Example 1, a typical cell including the λ-MnO₂ of Comparative Example 4c had a high OCV value of 1.78 V and a voltage profile that tracked about 100 mV above that of Comparative Example 1 for the first 25% depth of discharge and then smoothly decreased to a flat plateau at about 1 V extending from about 50% to 75% depth of discharge. Cells of Comparative Example 4c provided about 5% more gravimetric specific capacity to a 0.8 V cutoff voltage than the cells of Comparative Example 1. However, because of a 10% lower average discharge voltage, the cells of Comparative Example 4c have significantly lower energy density than those cells with a characteristic discharge voltage profile that more closely tracks that of Comparative Example 1 down to a CCV of about 1 V, for example, the cells of Examples 1b, 1c, 2, 3b3, and 4a.

TABLE 3
Discharge performance for alkaline cells with cathodes containing
λ-MnO₂

| | | | | Capacity | Capacity | Capacity |
|---|---|---|---|---|---|---|
| | | Ave | Ave | to 1 V | to 0.8 V | to 0.8 V |
| Ex | Cathode | OCV | CCV | 10 mA/g | 10 mA/g | 100 mA/g |
| No. | Active | (V) | (V) | (mAh/g) | (mAh/g) | (mAh/g) |
| C1 | Tronox | 1.60 | 1.23 | 263 | 287 | 163 |
| | AB | | | | | |
| 1a | X-MnO₂ | 1.72 | 1.21 | 258 | 314 | — |
| 1b | X-MnO₂ | 1.69 | 1.22 | 292 | 343 | 185 |
| 1c | X-MnO₂ | 1.69 | 1.23 | 287 | 336 | — |
| 2 | X-MnO₂ | 1.70 | 1.23 | 271 | 321 | — |
| C2 | X-MnO₂ | 1.70 | 1.21 | 233 | 312 | 186 |
| 3a3 | X-MnO₂ | 1.68 | 1.24 | 245 | 303 | — |
| 3b3 | X-MnO₂ | 1.67 | 1.22 | 263 | 331 | |
| 4a3 | X-MnO₂ | 1.66 | 1.22 | 289 | 342 | — |
| 4b | X-MnO₂ | 1.65 | 1.20 | 335 | 374 | 279 |
| C3a | X-MnO₂ | 1.77 | 1.15 | 178 | 241 | — |
| C3b | X-MnO₂ | 1.71 | 1.18 | 206 | 275 | — |
| C3c | X-MnO₂ | 1.76 | 1.12 | 165 | 281 | — |
| C4c | X-MnO₂ | 1.78 | 1.10 | 226 | 298 | — |

### Other Embodiments

While certain embodiments have been described herein above, other embodiments are possible. For example, formation of a CMD precursor suitable for the synthesis of a nominally stoichiometric lithium manganese spinel can be performed using aqueous oxidizing agents other than ammonium, sodium or potassium peroxydisulfate, for example, ozone gas, aqueous solutions of sodium or potassium peroxydiphosphate, sodium perborate, sodium or potassium hypochlorite, sodium chlorate, sodium or potassium bromate, sodium or potassium permanganate, and cerium(IV) ammonium sulfate or nitrate. In the case of the delithiation of a spinel, the use of an aqueous chemical oxidant such as a peroxydisulfate salt or ozone gas or a non-aqueous chemical oxidant in an organic solvent to oxidize the Mn³⁺ to Mn⁴⁺ in the lithium manganese oxide spinel can minimize loss of manganese via dissolution as Mn²⁺ as in the case of the acid extraction process. Non-aqueous oxidizing agents can include, for example, nitrosonium or nitronium tetrafluoroborate in acetonitrile, nitrosonium or nitronium hexafluorophosphate in acetonitrile, or oleum (i.e., SO₃/H₂SO₄) in sulfolane. In addition, ion-exchange of excess Li ions in spinel lattice sites by protons can occur during oxidation in aqueous solution at low pH (i.e., pH<1), but is less likely to occur at high pH. However, oxidation of OH⁻ ions to H and O₂ is a competing side-reaction that can serve to lower pH and facilitate Li⁺/H⁺ ion-exchange.

The nominally stoichiometric spinel also can be a metal-substituted spinel wherein a fraction of the manganese is substituted by another metal according to the general formula LiM_{y}Mn_{2-y}O₄, where 0<y≦1.0 and M can be selected from nickel, cobalt, titanium, copper, zinc, aluminum, or a combination thereof. Substitution of a divalent or trivalent metal for Mn⁴⁺ requires oxidation of a corresponding amount of the remaining Mn³⁺ to Mn⁴⁺ or the loss of oxygen to maintain overall electroneutrality of the spinel lattice. An increase in the amount of Mn³⁺ decreases the amount of Li⁺ that can be removed by the disproportionation reaction of Equation 1. Alternatively, the nominally stoichiometric spinel can be a metal-substituted spinel wherein the lithium can be partially or completely substituted by a mono-valent or divalent metal having an ionic radius comparable to that of Li⁺ in the tetrahedral 8a spinel lattice site, for example, magnesium (Mg²⁺), zinc (Zn²⁺), copper (Cu⁺, Cu²⁺), cobalt (Co²⁺), nickel (Ni²⁺), or a combination of these. Substitution of a divalent metal for Li⁺ requires a corresponding increase in the amount of Mn³⁺ or the creation of Mn⁴⁺ vacancies in order to maintain the overall electroneutrality of the lattice. The metal-substituted spinel can be treated with an aqueous acid solution to form the corresponding metal-substituted λ-MnO₂.

All references, such as patent applications, publications, and patents, referred to herein are incorporated by reference in their entirety.

Other embodiments are in the claims.

What is claimed is:

1. A method of making λ-MnO₂, comprising
(a) combining a lithium manganese oxide spinel having a formula of Li₁₊ₓMn₂₋ₓO₄, wherein −0.075≦x≦+0.075, and an aqueous acid solution at a temperature below 15° C. to form a slurry;
(b) stirring the slurry at a temperature below 15° C. to remove 90% or more of lithium from the lithium manganese oxide spinel to form λ-MnO₂;
(c) separating the λ-MnO₂ from a supernatant liquid;
(d) washing the separated λ-MnO₂ until the pH of the wash water is between 6 and 7; and
(e) drying the λ-MnO₂.

2. The method of claim 1, wherein the lithium manganese oxide spinel has a general formula of Li₁₊ₓMn₂₋ₓO₄, wherein −0.05≦x≦+0.05.

3. The method of claim 2, wherein the lithium manganese oxide spinel has a formula of Li₁₊ₓMn₂₋ₓO₄, wherein −0.02≦x≦+0.02.

4. The method of claim 1, wherein the lithium manganese oxide spinel has a lithium to manganese atom ratio of from 0.45 to 0.56.

5. The method of claim 1, wherein the lithium manganese oxide spinel is prepared from a chemically synthesized manganese oxide precursor selected from a CMD, a pCMD, an amorphous manganese oxide, and a poorly crystalline spinel-type manganese oxide.

6. The method of claim 5, wherein the CMD has a crystal structure selected from the group consisting of α-MnO₂, β-MnO₂, ramsdellite, γ-MnO₂, δ-MnO₂, ε-MnO₂, a mixture, a composite, and an intergrowth thereof.

7. The method of claim 5, wherein the pCMD has a crystal structure selected from the group consisting of α-MnO₂, β-MnO₂, ramsdellite, γ-MnO₂, ε-MnO₂, a mixture, a composite, and an intergrowth thereof.

8. The method of claim 1, wherein the lithium manganese oxide spinel has a refined cubic unit cell constant between 8.2350 Å and 8.2550 Å.

9. The method of claim 1, wherein the lithium manganese oxide spinel has a B.E.T. specific surface area between 1 and 10 m²/g.

10. The method of claim 1, wherein the lithium manganese oxide spinel has an average particle size of less than 15 μm.

11. The method of claim 1, wherein the lithium manganese oxide spinel has an average particle size of less than 5 μm.

12. The method of claim 1, wherein the aqueous acid solution is selected from the group consisting of aqueous solutions of sulfuric acid, nitric acid, hydrochloric acid, perchloric acid, toluenesulfonic acid, and trifluoromethylsulfonic acid.

13. The method of claim 1, wherein the concentration of the aqueous acid solution is between 0.1 and 12 M.

14. The method of claim 13, wherein the concentration of the aqueous acid solution is 6M.

15. The method of claim 1, wherein the slurry temperature is between 0° C. and 10° C.

16. The method of claim 1, wherein drying the λ-MnO₂ comprises drying in air at a temperature above 21° C.

17. The method of claim 1, wherein drying the λ-MnO₂ comprises drying under a vacuum.

18. The method of claim 1, wherein the formed λ-MnO₂ has a refined cubic unit cell constant between 8.0200 Å and 8.0500 Å.

19. The method of claim 1, wherein the formed λ-MnO₂ has a residual lithium content of between 0.1 wt % and 1.0 wt %.

20. The method of claim 1, wherein the formed λ-MnO₂ has a B.E.T. specific surface area between 10 and 30 m²/g.

21. The method of claim 1, wherein the formed λ-MnO₂ has a cumulative desorption pore volume of between 0.060 and 0.110 cm³/g.

22. The method of claim 1, wherein the formed λ-MnO₂ has a Scherrer X-ray crystallite size greater than 50 nm.

23. A method of making a cathode, comprising
(a) combining a lithium manganese oxide spinel and an aqueous acid solution at a temperature below 10° C. to form a slurry;
(b) stirring the slurry at a temperature below 10° C. to delithiate the lithium manganese oxide spinel to form λ-MnO₂;
(c) separating the λ-MnO₂ from a supernatant liquid;
(d) washing the separated λ-MnO₂;
(e) drying the λ-MnO₂; and
(f) incorporating the λ-MnO₂ into a cathode.

24. The method of claim 23, further comprising incorporating an optional binder and conductive additive particles selected from the group consisting of conductive carbon, silver, nickel, and mixtures thereof into a cathode.

25. The method of claim 24, wherein the conductive carbon is selected from graphite, carbon black, acetylene black, partially graphitized carbon black, carbon fibers, carbon nanofibers, vapor phase grown carbon fibers, graphene, carbon single wall nanotubes, and carbon multi-wall nanotubes, wherein the graphite is further selected from the group consisting of non-expanded natural graphite, non-expanded synthetic graphite, an oxidation-resistant graphite, and expanded graphite.

26. The method of claim 25, further comprising milling a dry mixture of the λ-MnO₂ and the oxidation-resistant graphite prior to incorporating the λ-MnO₂ into the cathode.

27. A method of making a battery, comprising:
(a) combining a lithium manganese oxide spinel and an aqueous acid solution at a temperature below 10° C. to form a slurry;
(b) stirring the slurry at a temperature below 10° C. to delithiated the lithium manganese oxide spinel to form λ-MnO₂;
(c) separating the λ-MnO₂ from a supernatant liquid;
(d) washing the separated λ-MnO₂;
(e) drying the λ-MnO₂;
(f) incorporating the λ-MnO₂ into a cathode; and
(g) incorporating the cathode into a battery.

28. The method of claim 27, further comprising milling a dry mixture of the λ-MnO₂ and an oxidation resistant graphite prior to incorporating the λ-MnO₂ into the cathode.

29. The method of claim 27, further comprising incorporating an anode, a separator and an electrolyte into the battery.

30. The battery of claim 29, wherein the anode comprises zinc metal particles, zinc alloy particles, or a mixture thereof.

31. The method of claim 30, wherein the battery has a gravimetric specific capacity of greater than 340 mAh/g of λ-MnO₂ when discharged at a nominal continuous discharge rate of 10 mA/g of λ-MnO₂ to a cutoff voltage of 0.8 V.

32. The method of claim 30, wherein the battery has a gravimetric specific capacity of greater than 370 mAh/g of λ-MnO₂ when discharged at a nominal continuous discharge rate of 10 mA/g of λ-MnO₂ to a cutoff voltage of 0.8 V.

33. The method of claim 30, wherein the battery has a gravimetric specific capacity of greater than 270 mAh/g of λ-MnO₂ when discharged at a nominal continuous discharge rate of 100 mA/g of λ-MnO₂ to a cutoff voltage of 0.8 V.
